(19) United States
(12) Patent Application Publication
(10) Pub. No.: US 2026/0279637 A1
(43) Pub. Date: Sep. 17, 2026

(54) MICROMAGNETIC DEVICE AND METHOD OF FORMING THE SAME

(71) Applicant: EnaChip inc., Jamesburg, NJ (US)

(72) Inventors: Trifon Liakopoulos, Bridgewater, NJ (US); Amrit Panda, Naperville, IL (US)

(73) Assignee: EnaChip inc., Jamesburg, NJ (US)

(21) Appl. No.: 19/552,145

(22) Filed: Feb. 27, 2026

Related U.S. Application Data
(63) Continuation of application No. 17/997,958, filed on May 4, 2021, now abandoned.
(60) Provisional application No. 62/704,316, filed on May 4, 2020.
(60) Provisional application No. 62/706,692, filed on Sep. 3, 2020.
(60) Provisional application No. 63/198,718, filed on Nov. 6, 2020.

(30) Foreign Application Priority Data
May 4, 2021 (WO) PCT/US2021/070500

(51) Int. Cl. H01F 10/14; H01F 10/13; H01F 10/16; H01F 10/187; H01F 41/32

(52) U.S. Cl. CPC H01F 10/14; H01F 10/138; H01F 10/16; H01F 10/187; H01F 41/32

(57) ABSTRACT

A micromagnetic device and method of forming the same. In one embodiment, the micromagnetic device includes a substrate, a seed layer over the substrate and a magnetic layer over the seed layer.

### RELATED APPLICATIONS

This application is a continuation and claims the benefit of U.S. patent application Ser. No. 17/997,958 entitled “Micromagnetic Device and Method of Forming the Same,” filed Nov. 4, 2022 which claims benefit of International Application No. PCT/US2021/070500 (WO 2021/226624), entitled “Micromagnetic Device and Method of Forming the Same,” filed May 4, 2021, and this application claims the benefit of U.S. Patent Application Ser. No. 62/704,316, entitled “Micromagnetic Device and Method of Forming the Same,” filed May 4, 2020, U.S. Patent Application Ser. No. 62/706,692, entitled “Micromagnetic Device and Method of Forming the Same,” filed Sep. 3, 2020, and U.S. Patent Application Ser. No. 63/198,718, entitled “Micromagnetic Device and Method of Forming the Same,” filed Nov. 6, 2020, which are incorporated herein by reference.

### FIELD OF THE INVENTION

The present disclosure is directed, in general, to power and signal processing and, in particular, to a micromagnetic device and method of forming the same.

### BACKGROUND

A continuing challenge in the design of compact power and signal processing devices for present and future markets is to produce product with smaller sizes and higher operating efficiencies. Prior industrial and research focus has been to produce semiconductor devices with smaller sizes, but has not made comparable progress for micromagnetic devices, which are necessary elements in these circuits. Producing micromagnetic devices, with very small overall dimensions and with low manufacturing costs has been a continuing design challenge.

To meet these challenges, new magnetic alloy compositions should be explored with improved properties and that can accommodate large product runs. New electroplating techniques would also be beneficial to achieve higher levels of magnetic performance and manufacturing repeatability. To achieve a high level of power conversion efficiency in end products, micromagnetic devices with thick winding turns would be advantageous.

A further challenge to produce a micromagnetic device with small dimensions is to avoid the production of pattern edge “horns” that tend to form during a thick electroplating process. Current through-photoresist electroplating approaches produce uneven surface features in magnetic or metallic layers that compromise manufacturing yields and affect product reliability in the field. Accordingly, what is needed in the art is a micromagnetic device that addresses these and other design and manufacturing challenges therefor.

### SUMMARY

These and other problems are generally solved or circumvented, and technical advantages are generally achieved, by advantageous embodiments of the present disclosure including a micromagnetic device and method of forming the same. In one embodiment, the micromagnetic device includes a substrate, a seed layer over the substrate and a magnetic layer over the seed layer.

The foregoing has outlined rather broadly the features and technical advantages of the present invention in order that the detailed description of the invention that follows can be better understood. Additional features and advantages of the invention will be described hereinafter, which form the subject of the claims of the invention. It should be appreciated by those skilled in the art that the conception and specific embodiment disclosed can be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention and the advantages thereof, reference is now made to the following descriptions taken in connection with the accompanying drawings, and which:

FIG. 1 illustrates a block diagram of an embodiment of a power converter including an integrated micromagnetic device;

FIG. 2 illustrates a schematic diagram of an embodiment of a power train of a power converter including an integrated micromagnetic device;

FIG. 3 illustrates a cross-sectional view of an embodiment of a micromagnetic device;

FIGS. 4 to 7 illustrate cross-sectional views of an embodiment of forming the micromagnetic device of FIG. 3;

FIG. 8 illustrates a cross-sectional view of another embodiment of a micromagnetic device;

FIGS. 9 to 16 illustrate cross-sectional views of an embodiment of forming the micromagnetic device of FIG. 8;

FIG. 17 illustrates a cross-sectional view of another embodiment of a micromagnetic device;

FIGS. 18 to 25 illustrate cross-sectional views of an embodiment of forming the micromagnetic device of FIG. 17;

FIG. 26 illustrates a cross-sectional view of another embodiment of a micromagnetic device;

FIGS. 27 to 36 illustrate cross-sectional views of an embodiment of forming the micromagnetic device of FIG. 26;

FIG. 37 illustrates a cross-sectional view of another embodiment of a micromagnetic device;

FIGS. 38 to 49 illustrate cross-sectional views of an embodiment of forming the micromagnetic device of FIG. 37;

FIG. 50 illustrates a cross-sectional view of another embodiment of a micromagnetic device;

FIGS. 51 to 66 illustrate cross-sectional views of an embodiment of forming the micromagnetic device of FIG. 50;

FIG. 67 illustrates a cross-sectional view of another embodiment of a micromagnetic device;

FIGS. 68 to 83 illustrate cross-sectional views of an embodiment of forming the micromagnetic device of FIG. 68;

FIG. 84 illustrates a cross-sectional view of another embodiment of a micromagnetic device;

FIGS. 85 to 97 illustrate cross-sectional views of an embodiment of forming the micromagnetic device of FIG. 84;

FIG. 98 illustrates a drawing showing an example of a roller wrapped with a photosensitive film;

FIG. 99 illustrates a diagram showing a process configuration employed to laminate the photosensitive film of FIG. 98 over a substrate;

FIG. 100 illustrates a diagram of an embodiment of a method of forming a micromagnetic device;

FIGS. 101 to 105 illustrate cross-sectional views of an embodiment of forming winding segments; and

FIGS. 106 to 111 illustrate cross-sectional views of another embodiment of forming winding segments.

Corresponding numerals and symbols in the different figures generally refer to corresponding parts unless otherwise indicated, and cannot be redescribed in the interest of brevity after the first instance. The FIGUREs are drawn to illustrate the relevant aspects of exemplary embodiments.

### DETAILED DESCRIPTION

The making and using of the present exemplary embodiments are discussed in detail below. It should be appreciated, however, that the embodiments provide many applicable inventive concepts that can be embodied in a wide variety of specific contexts. The specific embodiments described herein are merely illustrative of specific ways to make and use a micromagnetic device.

A device will be described herein with respect to exemplary embodiments in a specific context, namely, a broad class of industrial manufacturing processes for manufacturing a micromagnetic device. The specific embodiments are applicable to processes in many fields including, but are not limited to, manufacturing of micromagnetic devices that may include a metallic structure such as a metallic layer or winding and a magnetic structure.

A sequence of steps to produce a micromagnetic device formed according to the principles of the disclosure will now be described. In the interest of brevity, the details of some processing steps well known in the art may not be included in the descriptive material below. For example, without limitation, cleaning steps such as using deionized water or a reactive ionizing chamber may not be described, generally being ordinary techniques well known in the art. The particular concentration of reagents, the exposure times for photoresists, general processing temperatures, current densities for electroplating processes, chamber operating pressures, chamber gas concentrations, radio frequencies to produce ionized gases, etc., are often ordinary techniques well-known in the art, and will not always be included in the description below. Similarly, alternative reagents and processing techniques to accomplish substantially the same result, for example, the substitution of chemical-vapor deposition for sputtering, etc., may not be identified for each processing step, and such substitutions are included within the broad scope of the disclosure. The dimensions and material compositions of the exemplary embodiment described below also may be altered in alternative designs to meet particular design objectives, and are included within the broad scope of the disclosure.

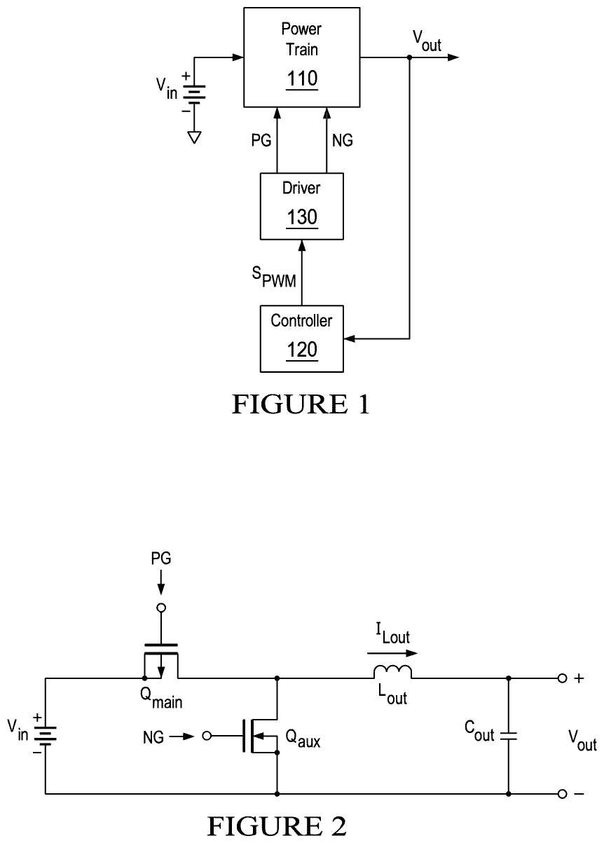

Referring initially to FIG. 1, illustrated is a block diagram of an embodiment of a power converter including an integrated micromagnetic device. The power converter includes a power train 110 coupled to a source of electrical power (represented by a battery) for providing an input voltage Vᵢₙ for the power converter. The power converter also includes a controller 120 and a driver 130, and provides power to a system (not shown) such as a microprocessor coupled to an output thereof. The power train 110 may employ a buck converter topology as illustrated and described with respect to FIG. 2 below. Of course, any number of converter topologies may benefit from the use of an integrated micromagnetic device constructed according to the principles of the disclosure and are well within the broad scope thereof.

The power train 110 receives an input voltage Vᵢₙ at an input thereof and provides a regulated output characteristic (e.g., an output voltage Vₒᵤₜ) to power a microprocessor or other load coupled to an output of the power converter. The controller 120 may be coupled to a voltage reference representing a desired characteristic such as a desired system voltage from an internal or external source associated with the microprocessor, and to the output voltage Vₒᵤₜ of the power converter. In accordance with the aforementioned characteristics, the controller 120 provides a signal S_{PWM} to control a duty cycle and a frequency of at least one power switch of the power train 110 to regulate the output voltage Vₒᵤₜ or another characteristic thereof by periodically coupling the integrated micromagnetic device to the input voltage Vᵢₙ.

In accordance with the aforementioned characteristics, a drive signal(s) [e.g., a first gate drive signal PG with duty cycle D functional for a P-channel metal-oxide semiconductor field-effect transistor (“MOSFET”) (referred to as a “PMOS”) power switch and a second gate drive signal NG with complementary duty cycle 1-D functional for a N-channel MOSFET (referred to as an “NMOS”) power switch] is provided by the driver 130 to control a duty cycle and a frequency of one or more power switches of the power converter, preferably to regulate the output voltage Vₒᵤₜ thereof.

Turning now to FIG. 2, illustrated is a schematic diagram of an embodiment of a power train of a power converter including an integrated micromagnetic device. While in the illustrated embodiment the power train employs a buck converter topology, those skilled in the art should understand that other converter topologies such as a forward converter topology or an active clamp topology are well within the broad scope of the invention.

The power train of the power converter receives an input voltage Vᵢₙ (e.g., an unregulated input voltage) from a source of electrical power (represented by a battery) at an input thereof and provides a regulated output voltage Vₒᵤₜ to power, for instance, a microprocessor at an output of the power converter. In keeping with the principles of a buck converter topology, the output voltage Vₒᵤₜ is generally less than the input voltage Vᵢₙ such that a switching operation of the power converter can regulate the output voltage Vₒᵤₜ. A main power switch Qₘₐᵢₙ, (e.g., a PMOS switch) is enabled to conduct by a gate drive signal PG for a primary interval (generally co-existent with a duty cycle “D” of the main power switch Qₘₐᵢₙ) and couples the input voltage Vᵢₙ to an output filter inductor Lₒᵤₜ, which may be advantageously formed as a micromagnetic device. During the primary interval, an inductor current I_{Lout} flowing through the output filter inductor Lₒᵤₜ increases as a current flows from the input to the output of the power train. An ac component of the inductor current I_{Lout} is filtered by an output capacitor Cₒᵤₜ.

During a complementary interval (generally co-existent with a complementary duty cycle “1-D” of the main power switch Qₘₐᵢₙ), the main power switch Qₘₐᵢₙ is transitioned to a non-conducting state and an auxiliary power switch Qₐᵤₓ (e.g., an NMOS switch) is enabled to conduct by a gate drive signal NG. The auxiliary power switch Qₐᵤₓ provides a path to maintain a continuity of the inductor current I_{Lout} flowing through the micromagnetic output filter inductor Lₒᵤₜ. During the complementary interval, the inductor current I_{Lout} through the output filter inductor Lₒᵤₜ decreases. In general, the duty cycle of the main and auxiliary power switches Qₘₐᵢₙ, Qₐᵤₓ may be adjusted to maintain a regulation of the output voltage Vₒᵤₜ of the power converter. Those skilled in the art should understand, however, that the conduction periods for the main and auxiliary power switches Qₘₐᵢₙ, Qₐᵤₓ may be separated by a small time interval to avoid cross conduction therebetween and beneficially to reduce the switching losses associated with the power converter.

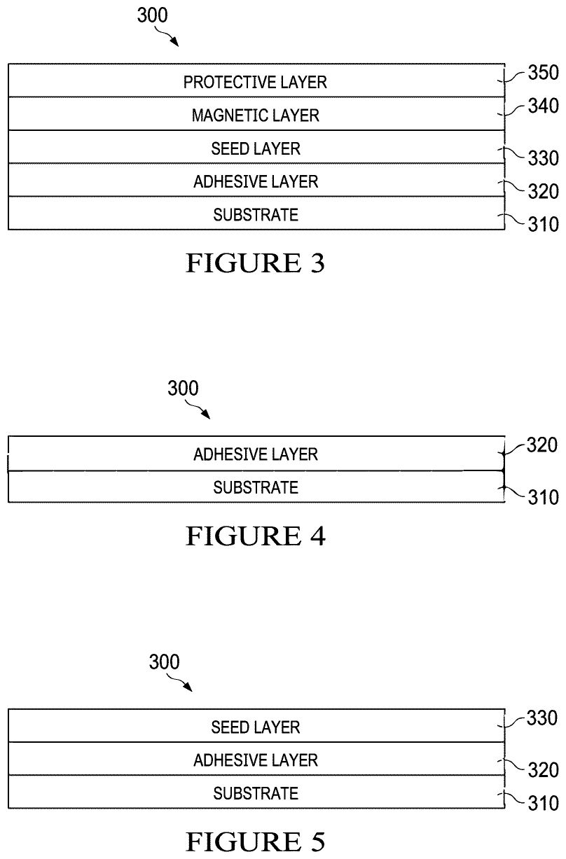

Turning now to FIG. 3, illustrated is a cross-sectional view of an embodiment of a micromagnetic device 300. The micromagnetic device 300 is formed on a substrate 310 with an adhesive layer 320 formed thereover. A seed layer 330 is formed over the adhesive layer 320 and a magnetic layer 340 is formed over the seed layer 330. A protective layer 350 is thereafter formed above the magnetic layer 340.

Turning now to FIGS. 4 to 7, illustrated are cross-sectional views of an embodiment of forming the micromagnetic device 300 of FIG. 3. Beginning with FIG. 4, the micromagnetic device 300 is constructed on a rigid or flexible substrate 310 such as silicon, glass, ceramic, molded polymer, flex or printed circuit board substrate, or other insulating material of approximately 0.1 to one (1) millimeter (“mm”) of thickness. An adhesive layer 320 such as nickel, chromium, titanium, or titanium tungsten is deposited at about 100-600 angstroms (“Å”) of thickness on an upper surface of the substrate 310 employing a sputtering, evaporation, lamination, cladding, electroplating or electroless process.

Turning now to FIG. 5, a seed layer 330 such as copper (or gold, titanium, titanium tungsten, nickel, nickel-iron, cobalt, ruthenium, platinum or titanium followed by a thin layer of copper or gold) is deposited on to the adhesive layer 320 employing a sputtering, evaporation, lamination, cladding, electroplating or electroless process for a later electroplating step. The seed layer 330 forms a conductive layer onto which a magnetic layer 340 will be deposited in a following processing step. The thickness of the seed layer 330 is in the range 1000-4000 Å preferably about 1500 Å. The seed layer 330 may include multiple layers of like or different materials that can serve as a seed layer. Of course, other layers described herein may also include multiple layers of like or different materials that can serve the purpose of the respective layer.

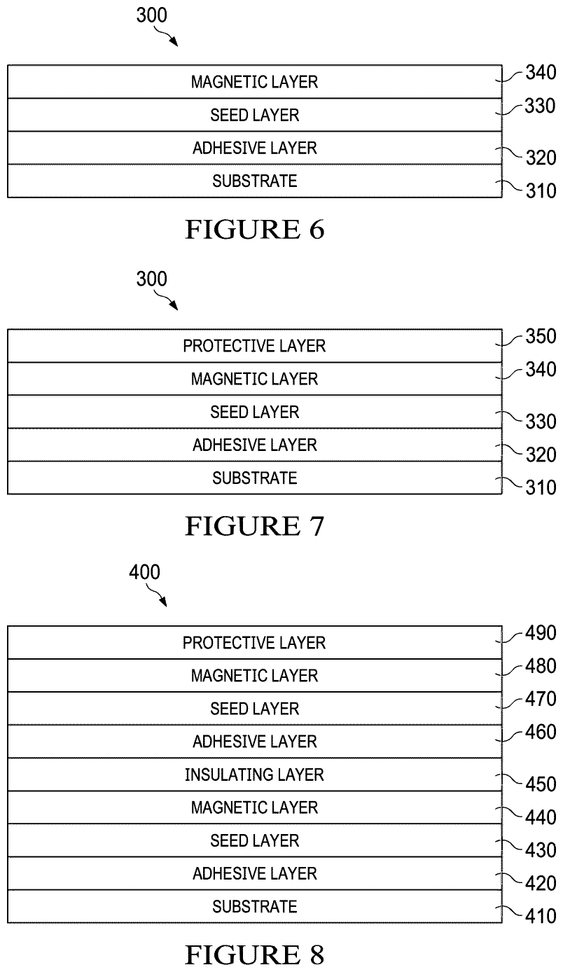

Turning now to FIG. 6, a magnetic layer 340 is deposited by a wet-bath electroplating process on the seed layer 330. The magnetic layer 340 may include boron in addition to iron, cobalt and phosphorous. The thickness of the magnetic layer 340 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other end product.

Regarding the magnetic layer 340, to provide an alloy with magnetic properties improved over alloys currently available, the quaternary alloy including iron, cobalt, boron and phosphorous is introduced. The magnetic layer 340 includes cobalt in the range of 1.0-8.0 atomic percent, boron in the range of 0.5-10 atomic percent, and iron in the range of 70-95 atomic percent. The magnetic layer 340 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the magnetic layer 340 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

Turning now to FIG. 7, a protective layer 350 such as titanium, titanium tungsten (“TiW”), chromium or nickel (or nickel-based) is deposited at about 100-1000 Å of thickness on an upper surface of the magnetic layer 340 employing a dry deposition, electroless or electroplating process. In accordance with the electroplating process, the micromagnetic device 300 is rinsed with carbon dioxide (“CO₂”)-saturated, de-ionized water and then immersed in an aqueous electrolyte (e.g., a titanium tungsten aqueous electrolyte) to form the protective layer 350 over the magnetic layer 340.

Thus, a micromagnetic device formed with a quaternary alloy with magnetic properties improved over those currently available, and related method, has been introduced herein formed over a substrate. In an advantageous embodiment, the quaternary alloy includes iron, cobalt, boron and phosphorus, and is an amorphous or nanocrystalline magnetic alloy.

In an embodiment, the micromagnetic device (300) includes a substrate (310), an adhesive layer (320) over the substrate (310), a seed layer (330) over the adhesive layer (320), and a magnetic layer (340, e.g., one to fifteen microns in thickness) over the seed layer (330) from a magnetic alloy including iron, cobalt, boron and phosphorous. A content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion (e.g., 70-95 atomic percent) of the magnetic alloy.

The magnetic alloy may also include at least one of sulfur, vanadium, chromium, rhodium, ruthenium, carbon, tin, bismuth, tungsten, and copper with a concentration in a range of 1 to 1000 parts per million. The magnetic alloy is an amorphous or nanocrystalline magnetic alloy. The adhesive layer (320) may include at least one of nickel, chromium, titanium, and titanium tungsten.

The seed layer (330) may include at least one of copper, gold, titanium, titanium tungsten, nickel, nickel-iron, cobalt, ruthenium, platinum and titanium followed by a thin layer of copper or gold. The seed layer (330) forms a conductive layer onto which the magnetic layer (340) is formed. The micromagnetic device (300) further includes a protective layer (350) over the magnetic layer (340). The protective layer (350) may include at least one of titanium, titanium tungsten, chromium, and nickel.

Turning now to FIG. 8, illustrated is a cross-sectional view of an embodiment of a micromagnetic device 400. The micromagnetic device 400 is formed on a substrate 410 with a first adhesive layer 420 formed thereover. A first seed layer 430 is formed over the first adhesive layer 420 and a first magnetic layer 440 is formed over the first seed layer 430. An insulating layer 450 is formed over the first magnetic layer 440. To accommodate multiple magnetic layers (e.g., two magnetic layers in the present embodiment), a second adhesive layer 460 is formed over the insulating layer 450, a second seed layer 470 is formed over the second adhesive layer 460 and a second magnetic layer 480 is formed over the second seed layer 470. A protective layer 490 is thereafter formed above the second magnetic layer 480.

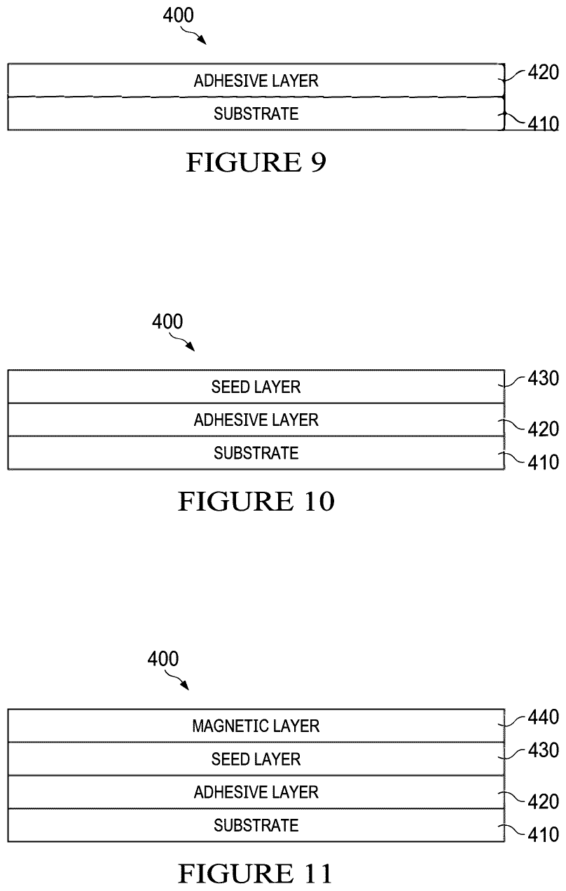

Turning now to FIGS. 9 to 16, illustrated are cross-sectional views of an embodiment of forming the micromagnetic device 400 of FIG. 8. Beginning with FIG. 9, the micromagnetic device 400 is constructed on a rigid or flexible substrate 410 such as silicon, glass, ceramic, molded polymer, flex or printed circuit board substrate, or other insulating material of approximately 0.1 to one (1) millimeter (“mm”) of thickness. A first adhesive layer 420 such as nickel, chromium, titanium, or titanium tungsten is deposited at about 100-600 angstroms (“Å”) of thickness on an upper surface of the substrate 410 employing a sputtering, evaporation, lamination, cladding, electroplating or electroless process.

Turning now to FIG. 10, a first seed layer 430 such as copper (or gold, titanium, titanium tungsten, nickel, nickel-iron, cobalt, ruthenium, platinum or titanium followed by a thin layer of copper or gold) is deposited on to the first adhesive layer 420 employing a sputtering, evaporation, lamination, cladding, electroplating or electroless process for a later electroplating step. The first seed layer 430 forms a conductive layer onto which a first magnetic layer 440 will be deposited in a following processing step. The thickness of the first seed layer 430 is in the range 1000-4000 Å preferably about 1500 Å. The first seed layer 430 may include multiple layers of like or different materials that can serve as a seed layer. Of course, other layers described herein may also include multiple layers of like or different materials that can serve the purpose of the respective layer.

Turning now to FIG. 11, a first magnetic layer 440 is deposited by a wet-bath electroplating process on the first seed layer 430. The first magnetic layer 440 may include boron in addition to iron, cobalt and phosphorous. The thickness of the first magnetic layer 440 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product.

Regarding the first magnetic layer 440, to provide an alloy with magnetic properties improved over alloys currently available, the quaternary alloy including iron, cobalt, boron and phosphorous is introduced. The first magnetic layer 440 includes cobalt in the range of 1.0-8.0 atomic percent, boron in the range of 0.5-10 atomic percent, and iron in the range of 70-95 atomic percent. The first magnetic layer 440 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the first magnetic layer 440 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

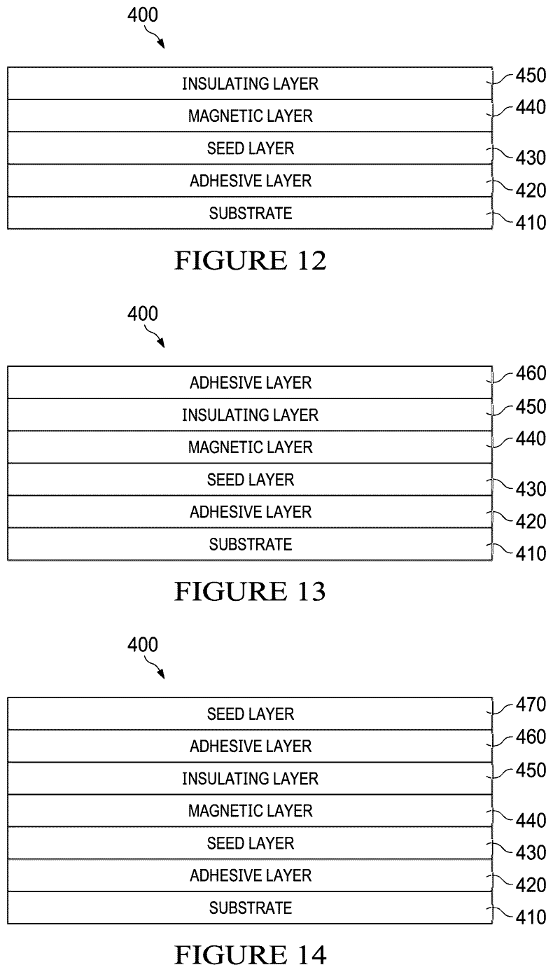

Turning now to FIG. 12, an insulating layer 450 is deposited on the first magnetic layer 450. The insulating layer 450 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the insulating layer 450 is about, but not limited to, 0.02 to 5 microns (“μm”).

The thickness of the insulating layer 450 can affect residual mechanical stress in the product due to differential thermal expansion of conductive, magnetic, and other layers during device processing steps. The thickness of the insulating layer 450 can be adjusted using simulation or experimental techniques to produce a die with low residual mechanical stress after completion of micromagnetic device processing.

The insulating layer 450 can be formed with a deposition of a patternable layer (e.g., photosensitive photoresist, screen printed polymer or laser patternable coating with no or very low electric conductivity) on top of the first magnetic layer 440, which is then hard cured by heating or other means. The insulating layer 450 can be a semi-insulating layer such as polypyrrole with a low level of electrical conductivity deposited by an electroplating process. Following electroplating, the insulating layer 450 is cured and annealed, which substantially reduces its conductivity. The result is a sufficiently high level of resistivity is obtained for an insulating layer 450 in the micromagnetic device 400, thereby simplifying the total manufacturing process.

Turning now to FIG. 13, a second adhesive layer 460 is formed over the insulating layer 450. The second adhesive layer 460 such as nickel, chromium, titanium, or titanium tungsten is deposited at about 100-600 angstroms (“Å”) of thickness on the insulating layer 450 employing a sputtering, evaporation, lamination, cladding, electroplating or electroless process.

Turning now to FIG. 14, a second seed layer 470 such as copper (or gold, titanium, titanium tungsten, nickel, nickel-iron, cobalt, ruthenium, platinum or titanium followed by a thin layer of copper or gold) is deposited on to the second adhesive layer 460 employing a sputtering, evaporation, lamination, cladding, electroplating or electroless process for a later electroplating step. The second seed layer 470 forms a conductive layer onto which a second magnetic layer 480 will be deposited in a following processing step. The thickness of the second seed layer 470 is in the range 1000-4000 Å preferably about 1500 Å. The second seed layer 470 may include multiple layers of like or different materials that can serve as a seed layer. Of course, other layers described herein may also include multiple layers of like or different materials that can serve the purpose of the respective layer.

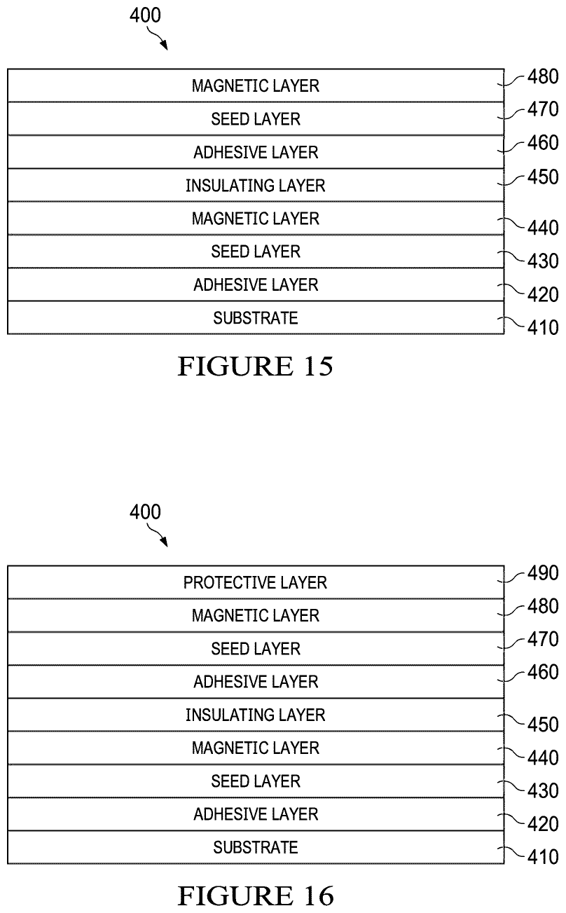

Turning now to FIG. 15, a second magnetic layer 480 is deposited by a wet-bath electroplating process on the second seed layer 470. The second magnetic layer 480 includes boron in addition to iron, cobalt and phosphorous. The thickness of the second magnetic layer 480 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product. The second magnetic layer 480 has analogous properties to the first magnetic layer 440 as described above. As mentioned above, multiple magnetic layers with the corresponding intervening and surrounding layers may be incorporated into the micromagnetic device 400. The same principle applies to other micromagnetic devices disclosed herein. Also, as an example of a multi-core magnetic device, see International Publication No. WO2017/205644, entitled “Laminated Magnetic Cores,” by Allen, et al., which is incorporated herein by reference.

Turning now to FIG. 16, a protective layer 490 such as titanium, titanium tungsten (“TiW”), chromium or nickel (or nickel-based) is deposited at about 100-1000 Å of thickness on an upper surface of the second magnetic layer 480 employing a dry deposition, electroless or electroplating process. In accordance with the electroplating process, the micromagnetic device 400 is rinsed with carbon dioxide (“CO₂”)-saturated, de-ionized water and then immersed in an aqueous electrolyte (e.g., a titanium tungsten aqueous electrolyte) to form the protective layer 490 over the second magnetic layer 480.

Thus, a micromagnetic device formed with a quaternary alloy with magnetic properties improved over those currently available, and related method, has been introduced herein formed over a substrate. In an advantageous embodiment, the quaternary alloy includes iron, cobalt, boron and phosphorus, and is an amorphous or nanocrystalline magnetic alloy.

In an embodiment, the micromagnetic device (400) includes a substrate (410), a first adhesive layer (420) and a first seed layer (430) over the substrate (410), and a first magnetic layer (440, e.g., one to fifteen microns in thickness) over the first adhesive layer (420) and first seed layer (430) from a magnetic alloy including iron, cobalt, boron and phosphorous. The micromagnetic device (400) also includes a second adhesive layer (460) and second seed layer (470) over the first magnetic layer (440), and second magnetic layer (480, e.g., one to fifteen microns in thickness) over the second adhesive layer (460) and second seed layer (470) from a magnetic alloy including iron, cobalt, boron and phosphorous. A content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion (e.g., 70-95 atomic percent) of the magnetic alloy.

The magnetic alloy may also include at least one of sulfur, vanadium, chromium, rhodium, ruthenium, carbon, tin, bismuth, tungsten, and copper with a concentration in a range of 1 to 1000 parts per million. The magnetic alloy is an amorphous or nanocrystalline magnetic alloy. The first and second adhesive layers (420, 460) may include at least one of nickel, chromium, titanium, and titanium tungsten.

The first and second seed layers (430, 470) may include at least one of copper, gold, titanium, titanium tungsten, nickel, nickel-iron, cobalt, ruthenium, platinum and titanium followed by a thin layer of copper or gold. The first and second seed layers (430, 470) form a conductive layer onto which the first and second magnetic layers (440, 480), respectively, are formed.

The micromagnetic device (400) also includes an insulting or semi-insulating layer (450) between the first and second magnetic layers (440, 480). The insulating layer (450, e.g., a polymer, an aluminum oxide or silicon dioxide) can affect residual mechanical stress in the product due to differential thermal expansion of conductive, magnetic, and other layers during device processing steps. The micromagnetic device (400) further includes a protective layer (490) over the second magnetic layer (480). The protective layer (490) may include at least one of titanium, titanium tungsten, chromium, and nickel.

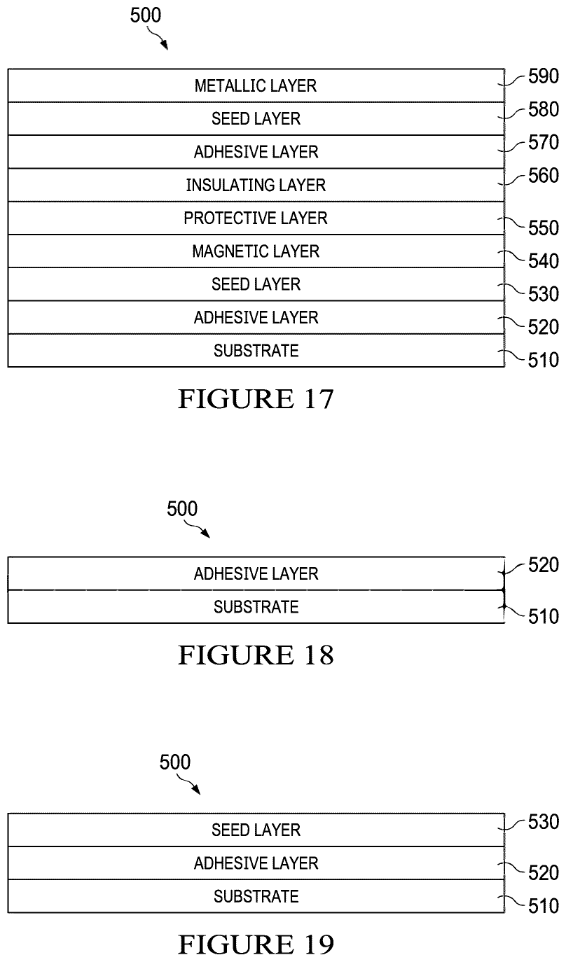

Turning now to FIG. 17, illustrated is a cross-sectional view of an embodiment of a micromagnetic device 500. The micromagnetic device 500 is formed on a substrate 510 with a first adhesive layer 520 formed thereover. A first seed layer 530 is formed over the first adhesive layer 520 and a magnetic layer 540 is formed over the first seed layer 530. A protective layer 550 is formed over the magnetic layer 540, and an insulating layer 560 is formed over the protective layer 550. A second adhesive layer 570 is formed over the insulating layer 560, a second seed layer 580 is formed over the second adhesive layer 570 and a metallic layer 590 is formed over the second seed layer 580.

Turning now to FIGS. 18 to 25, illustrated are cross-sectional views of an embodiment of forming the micromagnetic device 500 of FIG. 17. Beginning with FIG. 18, the micromagnetic device 500 is constructed on a rigid or flexible substrate 510 such as silicon, glass, ceramic, molded polymer, flex or printed circuit board substrate, or other insulating material of approximately 0.1 to one (1) millimeter (“mm”) of thickness. A first adhesive layer 520 such as nickel, chromium, titanium, or titanium tungsten is deposited at about 100-600 angstroms (“Å”) of thickness on an upper surface of the substrate 510 employing a sputtering, evaporation, lamination, cladding, electroplating or electroless process.

Turning now to FIG. 19, a first seed layer 530 such as copper (or gold, titanium, titanium tungsten, nickel, nickel-iron, cobalt, ruthenium, platinum or titanium followed by a thin layer of copper or gold) is deposited on to the first adhesive layer 520 employing a sputtering, evaporation, lamination, cladding, electroplating or electroless process for a later electroplating step. The first seed layer 530 forms a conductive layer onto which a first magnetic layer 540 will be deposited in a following processing step. The thickness of the first seed layer 530 is in the range 1000-4000 Å preferably about 1500 Å. The first seed layer 530 may include multiple layers of like or different materials that can serve as a seed layer. Of course, other layers described herein may also include multiple layers of like or different materials that can serve the purpose of the respective layer.

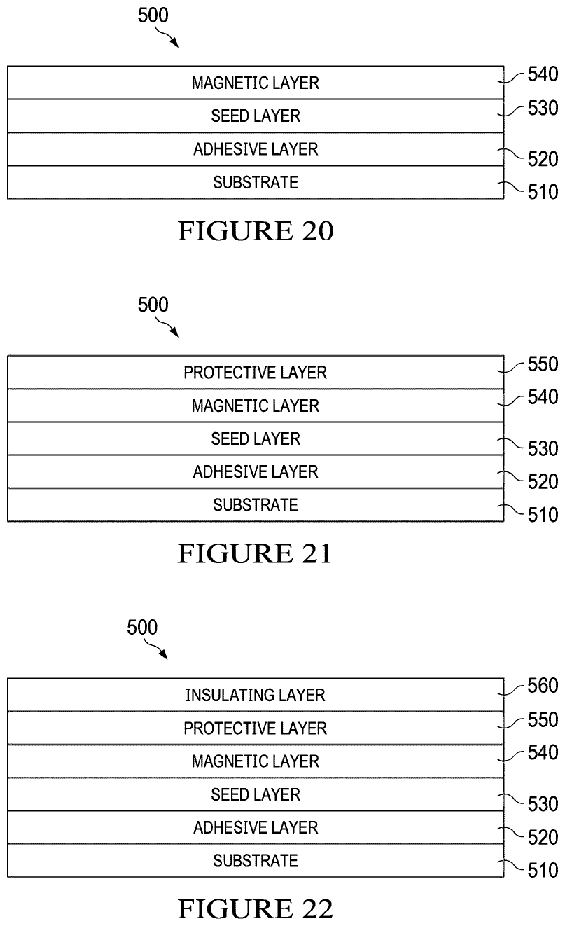

Turning now to FIG. 20, a magnetic layer 540 is deposited by a wet-bath electroplating process on the first seed layer 530. The magnetic layer 540 includes boron in addition to iron, cobalt and phosphorous. The thickness of the magnetic layer 540 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product.

Regarding the magnetic layer 540, to provide an alloy with magnetic properties improved over alloys currently available, the quaternary alloy including iron, cobalt, boron and phosphorous is introduced. The magnetic layer 540 includes cobalt in the range of 1.0-8.0 atomic percent, boron in the range of 0.5-10 atomic percent, and iron in the range of 70-95 atomic percent. The magnetic layer 540 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the magnetic layer 540 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

Turning now to FIG. 21, a protective layer 550 such as titanium, titanium tungsten (“TiW”), chromium or nickel (or nickel-based) is deposited at about 100-1000 Å of thickness on an upper surface of the magnetic layer 540 employing a dry deposition, electroless or electroplating process. In accordance with the electroplating process, the micromagnetic device 500 is rinsed with carbon dioxide (“CO₂”)-saturated, de-ionized water and then immersed in an aqueous electrolyte (e.g., a titanium tungsten aqueous electrolyte) to form the protective layer 550 over the magnetic layer 540.

Turning now to FIG. 22, an insulating layer 560 is deposited on the protective layer 550. The insulating layer 560 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the insulating layer 560 is about, but not limited to, 0.02 to 5 microns (“μm”).

The thickness of the insulating layer 560 can affect residual mechanical stress in the product due to differential thermal expansion of conductive, magnetic, and other layers during device processing steps. The thickness of the insulating layer 560 can be adjusted using simulation or experimental techniques to produce a die with low residual mechanical stress after completion of micromagnetic device processing.

The insulating layer 560 can be formed with a deposition of a patternable layer (e.g., photosensitive photoresist, screen printed polymer or laser patternable coating with no or very low electric conductivity) on top of the protective layer 550, which is then hard cured by heating or other means. The insulating layer 560 can be a semi-insulating layer such as polypyrrole with a low level of electrical conductivity deposited by an electroplating process. Following electroplating, the insulating layer 560 is cured and annealed, which substantially reduces its conductivity. The result is a sufficiently high level of resistivity is obtained for an insulating layer 560 in the micromagnetic device 500, thereby simplifying the total manufacturing process.

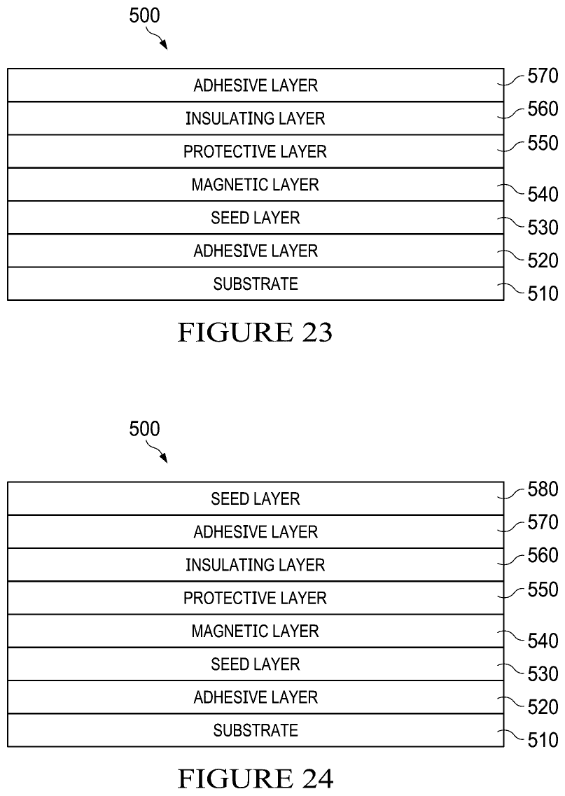

Turning now to FIG. 23, a second adhesive layer 570 is formed over the insulating layer 560. The second adhesive layer 570 such as nickel, chromium, titanium, or titanium tungsten is deposited at about 100-600 angstroms (“Å”) of thickness on the insulating layer 560 employing a sputtering, evaporation, lamination, cladding, electroplating or electroless process.

Turning now to FIG. 24, a second seed layer 580 such as copper (or gold, titanium, titanium tungsten, nickel, nickel-iron, cobalt, ruthenium, platinum or titanium followed by a thin layer of copper or gold) is deposited on to the second adhesive layer 570 employing a sputtering, evaporation, lamination, cladding, electroplating or electroless process for a later electroplating step. The second seed layer 580 forms a conductive layer onto which a metallic layer 590 will be deposited in a following processing step. The thickness of the second seed layer 580 is in the range 1000-4000 Å preferably about 1500 Å. The second seed layer 580 may include multiple layers of like or different materials that can serve as a seed layer. Of course, other layers described herein may also include multiple layers of like or different materials that can serve the purpose of the respective layer.

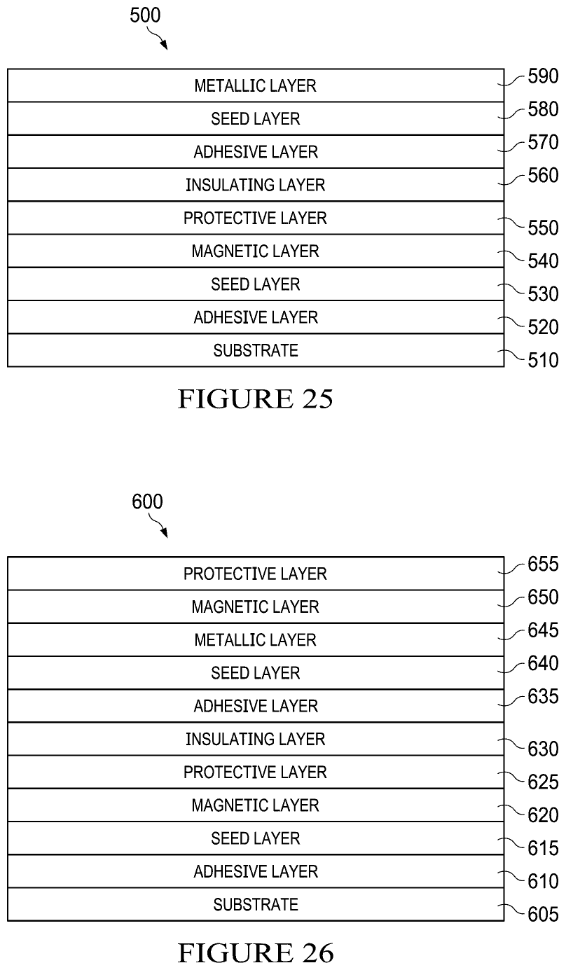

Turning now to FIG. 25, a metallic layer 590 is deposited by a wet-bath electroplating process on the second seed layer 580. The metallic layer 590 may be formed from copper, nickel, gold, aluminum, combination thereof (such as a stack of copper, nickel and gold) or other electrically conductive metallic material. The thickness of the metallic layer 590 is, without limitation, about 20 microns (“μm”).

Thus, a micromagnetic device formed with a quaternary alloy with magnetic properties improved over those currently available, and related method, has been introduced herein formed over a substrate. In an advantageous embodiment, the quaternary alloy includes iron, cobalt, boron and phosphorus, and is an amorphous or nanocrystalline magnetic alloy.

In an embodiment, the micromagnetic device (500) includes a substrate (510), a first adhesive layer (520) over the substrate (510), a first seed layer (530) over the first adhesive layer (520), and a magnetic layer (540, e.g., one to fifteen microns in thickness) over the first seed layer (530) from a magnetic alloy including iron, cobalt, boron and phosphorous. A content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion (e.g., 70-95 atomic percent) of the magnetic alloy. The micromagnetic device (500) also includes a metallic layer (590) over the magnetic layer (540). The metallic layer (590) may be about 20 microns thick formed from copper, gold, aluminum, or other electrically conductive metallic material.

The magnetic alloy may also include at least one of sulfur, vanadium, chromium, rhodium, ruthenium, carbon, tin, bismuth, tungsten, and copper with a concentration in a range of 1 to 1000 parts per million. The magnetic alloy is an amorphous or nanocrystalline magnetic alloy.

The micromagnetic device (500) also includes a protective layer (550), an insulting layer (560), and a second adhesive layer (570) and a second seed layer (580) between the magnetic layer (540) and the metallic layer (590). The first and second adhesive layers (520, 570) may include at least one of nickel, chromium, titanium, and titanium tungsten. The first and second seed layers (530, 580) may include at least one of copper, gold, titanium, titanium tungsten, nickel, nickel-iron, cobalt, ruthenium, platinum and titanium followed by a thin layer of copper or gold. The first and second seed layers (530, 580) form a conductive layer onto which the magnetic layer (540) and the metallic layer (590), respectively, are formed. The insulating layer (560, e.g., a polymer, an aluminum oxide or silicon dioxide) can affect residual mechanical stress in the product due to differential thermal expansion of conductive, magnetic, and other layers during device processing steps. The protective layer (550) may include at least one of titanium, titanium tungsten, chromium, and nickel.

Turning now to FIG. 26, illustrated is a cross-sectional view of an embodiment of a micromagnetic device 600. The micromagnetic device 600 is formed on a substrate 605 with a first adhesive layer 610 formed thereover. A first seed layer 615 is formed over the first adhesive layer 610 and a first magnetic layer 620 is formed over the first seed layer 615. A first protective layer 625 is formed over the first magnetic layer 620, and an insulating layer 630 is formed over the first protective layer 625. A second adhesive layer 635 is formed over the insulating layer 630, a second seed layer 640 is formed over the second adhesive layer 635 and a metallic layer 645 is formed over the second seed layer 640. A second magnetic layer 650 is formed over the metallic layer 645, and a second protective layer 655 is formed over the second magnetic layer 650.

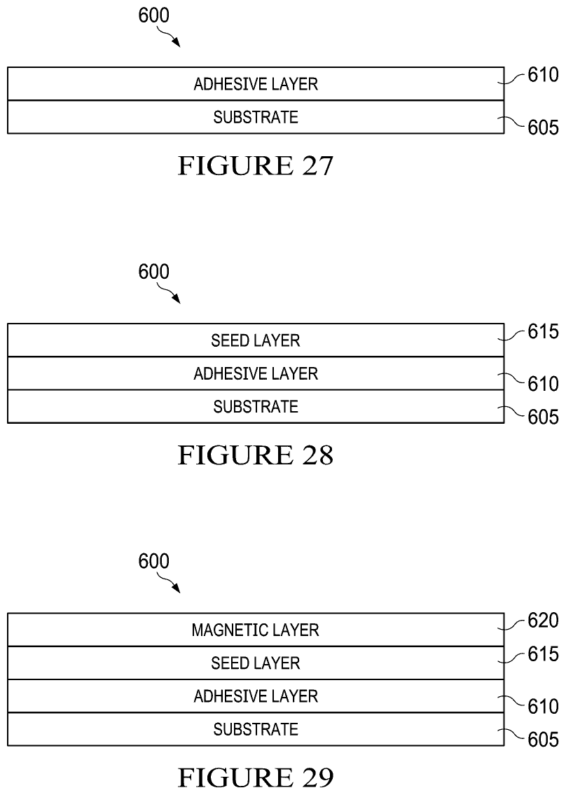

Turning now to FIGS. 27 to 36, illustrated are cross-sectional views of an embodiment of forming the micromagnetic device 600 of FIG. 26. Beginning with FIG. 27, the micromagnetic device 600 is constructed on a rigid or flexible substrate 605 such as silicon, glass, ceramic, molded polymer, flex or printed circuit board substrate, or other insulating material of approximately 0.1 to one (1) millimeter (“mm”) of thickness. A first adhesive layer 610 such as nickel, chromium, titanium, or titanium tungsten is deposited at about 100-600 angstroms (“Å”) of thickness on an upper surface of the substrate 605 employing a sputtering, evaporation, lamination, cladding, electroplating or electroless process.

Turning now to FIG. 28, a first seed layer 615 such as copper (or gold, titanium, titanium tungsten, nickel, nickel-iron, cobalt, ruthenium, platinum or titanium followed by a thin layer of copper or gold) is deposited on to the first adhesive layer 610 employing a sputtering, evaporation, lamination, cladding, electroplating or electroless process for a later electroplating step. The first seed layer 615 forms a conductive layer onto which a first magnetic layer 620 will be deposited in a following processing step.

The thickness of the first seed layer 615 is in the range 1000-4000 Å preferably about 1500 Å. The first seed layer 615 may include multiple layers of like or different materials that can serve as a seed layer. Of course, other layers described herein may also include multiple layers of like or different materials that can serve the purpose of the respective layer.

Turning now to FIG. 29, a first magnetic layer 620 is deposited by a wet-bath electroplating process on the first seed layer 615. The first magnetic layer 620 includes boron in addition to iron, cobalt and phosphorous. The thickness of the first magnetic layer 620 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product.

Regarding the first magnetic layer 620, to provide an alloy with magnetic properties improved over alloys currently available, the quaternary alloy including iron, cobalt, boron and phosphorous is introduced. The first magnetic layer 620 includes cobalt in the range of 1.0-8.0 atomic percent, boron in the range of 0.5-10 atomic percent, and iron in the range of 70-95 atomic percent. The first magnetic layer 620 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the first magnetic layer 620 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

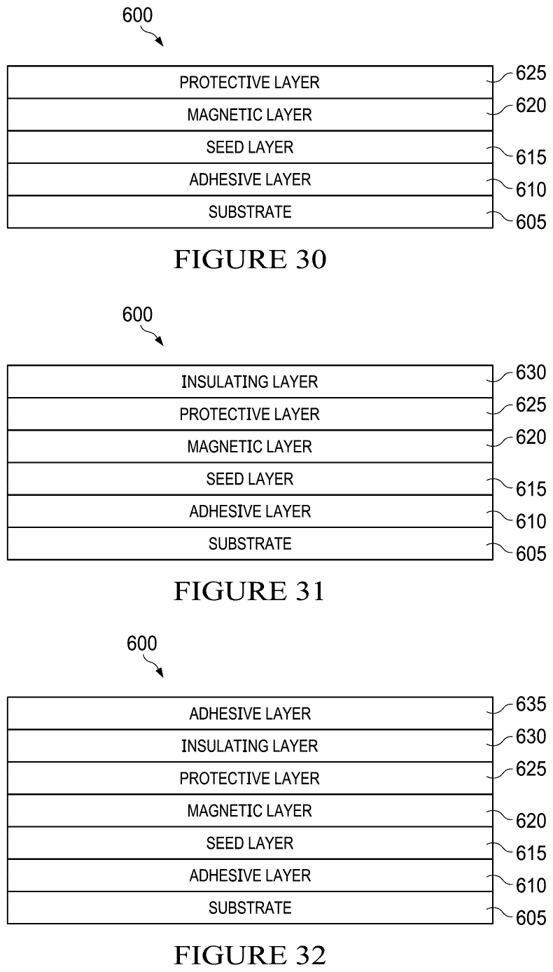

Turning now to FIG. 30, a first protective layer 625 such as titanium, titanium tungsten (“TiW”), chromium or nickel (or nickel-based) is deposited at about 100-1000 Å of thickness on an upper surface of the first magnetic layer 620 employing a dry deposition, electroless or electroplating process. In accordance with the electroplating process, the micromagnetic device 600 is rinsed with carbon dioxide (“CO₂”)-saturated, de-ionized water and then immersed in an aqueous electrolyte (e.g., a titanium tungsten aqueous electrolyte) to form the first protective layer 625 over the first magnetic layer 620.

Turning now to FIG. 31, an insulating layer 630 is deposited on the first protective layer 625. The insulating layer 630 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the insulating layer 630 is about, but not limited to, 0.02 to 5 microns (“μm”).

The thickness of the insulating layer 630 can affect residual mechanical stress in the product due to differential thermal expansion of conductive, magnetic, and other layers during device processing steps. The thickness of the insulating layer 630 can be adjusted using simulation or experimental techniques to produce a die with low residual mechanical stress after completion of micromagnetic device processing.

The insulating layer 630 can be formed with a deposition of a patternable layer (e.g., photosensitive photoresist, screen printed polymer or laser patternable coating with no or very low electric conductivity) on top of the first protective layer 625, which is then hard cured by heating or other means. The insulating layer 630 can be a semi-insulating layer such as polypyrrole with a low level of electrical conductivity deposited by an electroplating process. Following electroplating, the insulating layer 630 is cured and annealed, which substantially reduces its conductivity. The result is a sufficiently high level of resistivity is obtained for an insulating layer 630 in the micromagnetic device 600, thereby simplifying the total manufacturing process.

Turning now to FIG. 32, a second adhesive layer 635 is formed over the insulating layer 630. The second adhesive layer 635 such as nickel, chromium, titanium, or titanium tungsten is deposited at about 100-600 angstroms (“Å”) of thickness on the insulating layer 630 employing a sputtering, evaporation, lamination, cladding, electroplating or electroless process.

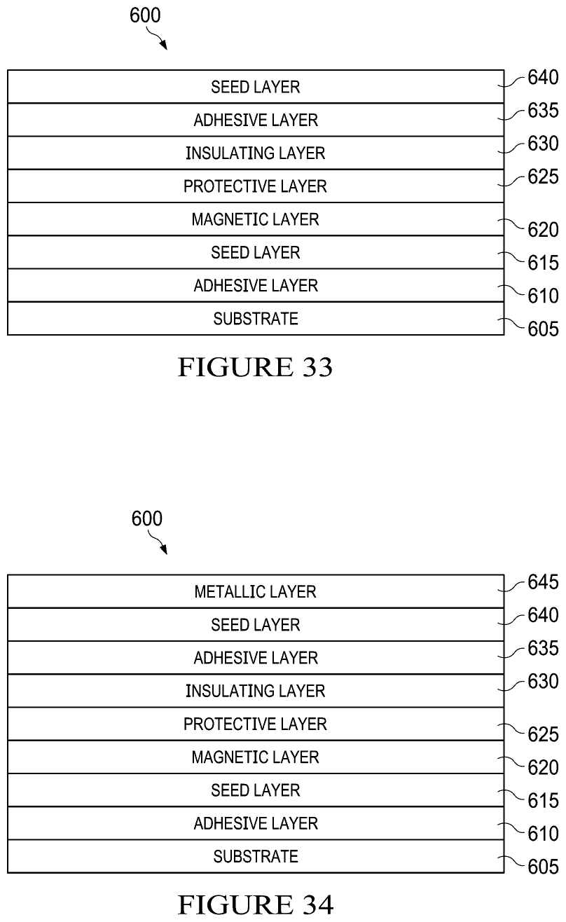

Turning now to FIG. 33, a second seed layer 640 such as copper (or gold, titanium, titanium tungsten, nickel, nickel-iron, cobalt, ruthenium, platinum or titanium followed by a thin layer of copper or gold) is deposited on to the second adhesive layer 635 employing a sputtering, evaporation, lamination, cladding, electroplating or electroless process for a later electroplating step. The second seed layer 640 forms a conductive layer onto which a metallic layer 645 will be deposited in a following processing step. The thickness of the second seed layer 640 is in the range 1000-4000 Å preferably about 1500 Å. The second seed layer 640 may include multiple layers of like or different materials that can serve as a seed layer. Of course, other layers described herein may also include multiple layers of like or different materials that can serve the purpose of the respective layer.

Turning now to FIG. 34, a metallic layer 645 is deposited by a wet-bath electroplating process on the second seed layer 640. The metallic layer 645 may be formed from copper, nickel, gold, aluminum, combination thereof (such as a stack of copper, nickel and gold) or other electrically conductive metallic material. The thickness of the metallic layer 645 is, without limitation, about 20 microns (“μm”).

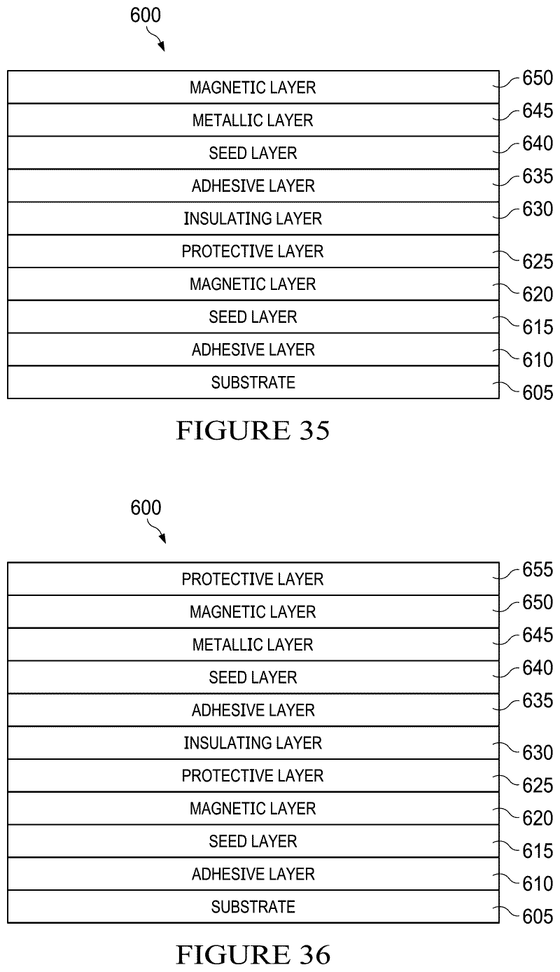

Turning now to FIG. 35, a second magnetic layer 650 is deposited by a wet-bath electroplating process on the metallic layer 645. The second magnetic layer 650 includes boron in addition to iron, cobalt and phosphorous. The thickness of the second magnetic layer 650 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product.

Regarding the second magnetic layer 650, to provide an alloy with magnetic properties improved over alloys currently available, the quaternary alloy including iron, cobalt, boron and phosphorous is introduced. The second magnetic layer 650 includes cobalt in the range of 1.0-8.0 atomic percent, boron in the range of 0.5-10 atomic percent, and iron in the range of 70-95 atomic percent. The second magnetic layer 650 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the second magnetic layer 650 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

Turning now to FIG. 36, a second protective layer 655 such as titanium, titanium tungsten (“TiW”), chromium or nickel (or nickel-based) is deposited at about 100-1000 Å of thickness on an upper surface of the second magnetic layer 650 employing a dry deposition, electroless or electroplating process. In accordance with the electroplating process, the micromagnetic device 600 is rinsed with carbon dioxide (“CO₂”)-saturated, de-ionized water and then immersed in an aqueous electrolyte (e.g., a titanium tungsten aqueous electrolyte) to form the second protective layer 655 over the second magnetic layer 650. Thus, a micromagnetic device formed with a quaternary alloy with magnetic properties improved over those currently available, and related method, has been introduced herein formed over a substrate. In an advantageous embodiment, the quaternary alloy includes iron, cobalt, boron and phosphorus, and is an amorphous or nanocrystalline magnetic alloy.

In an embodiment, the micromagnetic device (600) includes a substrate (605), a first adhesive layer (610) over the substrate (605), a first seed layer (615) over the first adhesive layer (610), and a first magnetic layer (620, e.g., one to fifteen microns in thickness) over the first seed layer (615) from a magnetic alloy including iron, cobalt, boron and phosphorous. A content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion (e.g., 70-95 atomic percent) of the magnetic alloy. The micromagnetic device (600) includes a metallic layer (645) over the first magnetic layer (620). The metallic layer (645) may be about 20 microns thick formed from copper, gold, aluminum, or other electrically conductive metallic material.

The magnetic alloy may also include at least one of sulfur, vanadium, chromium, rhodium, ruthenium, carbon, tin, bismuth, tungsten, and copper with a concentration in a range of 1 to 1000 parts per million. The magnetic alloy is an amorphous or nanocrystalline magnetic alloy.

The micromagnetic device (600) also includes a first protective layer (625), an insulting layer (630), a second adhesive layer (635) and a second seed layer (640) between the first magnetic layer (620) and the metallic layer (645). The micromagnetic device (600) also includes a second magnetic layer (650, analogous to the first magnetic layer 620) above the metallic layer (645), and a second protective layer (655) above the second magnetic layer (650). The first and second adhesive layers (610, 635) may include at least one of nickel, chromium, titanium, and titanium tungsten. The first and second seed layers (615, 640) may include at least one of copper, gold, titanium, titanium tungsten, nickel, nickel-iron, cobalt, ruthenium, platinum and titanium followed by a thin layer of copper or gold. The first and second seed layers (615, 640) form a conductive layer onto which the first magnetic layer (620) and the metallic layer (645), respectively, are formed. The insulating layer (630, e.g., a polymer, an aluminum oxide or silicon dioxide) can affect residual mechanical stress in the product due to differential thermal expansion of conductive, magnetic, and other layers during device processing steps. The first and second protective layers (625, 655) may include at least one of titanium, titanium tungsten, chromium, and nickel.

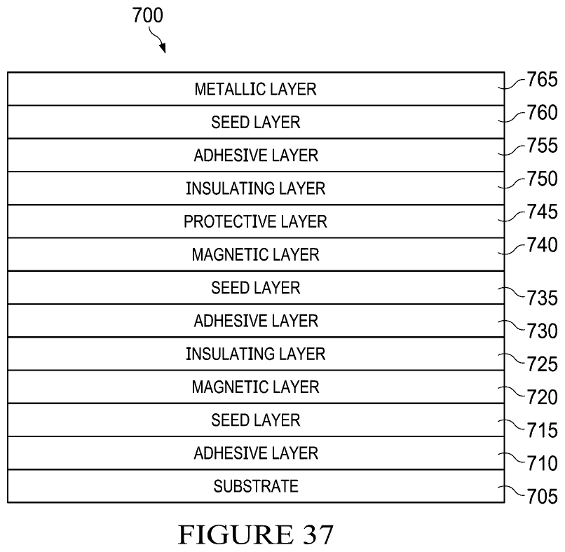

Turning now to FIG. 37, illustrated is a cross-sectional view of an embodiment of a micromagnetic device 700. The micromagnetic device 700 is formed on a substrate 705 with a first adhesive layer 710 formed thereover. A first seed layer 715 is formed over the first adhesive layer 710, and a first magnetic layer 720 is formed over the first seed layer 715. A first insulating layer 725 is formed over the first magnetic layer 720, and a second adhesive layer 730 is formed over the first insulating layer 725. A second seed layer 735 is formed over the second adhesive layer 730, and a second magnetic layer 740 is formed over the second seed layer 735. A protective layer 745 is formed over the second magnetic layer 740, and a second insulating layer 750 is formed over the protective layer 745. A third adhesive layer 755 is formed over the second insulating layer 750, a third seed layer 760 is formed over the third adhesive layer 755, and a metallic layer 765 is formed over the third seed layer 760.

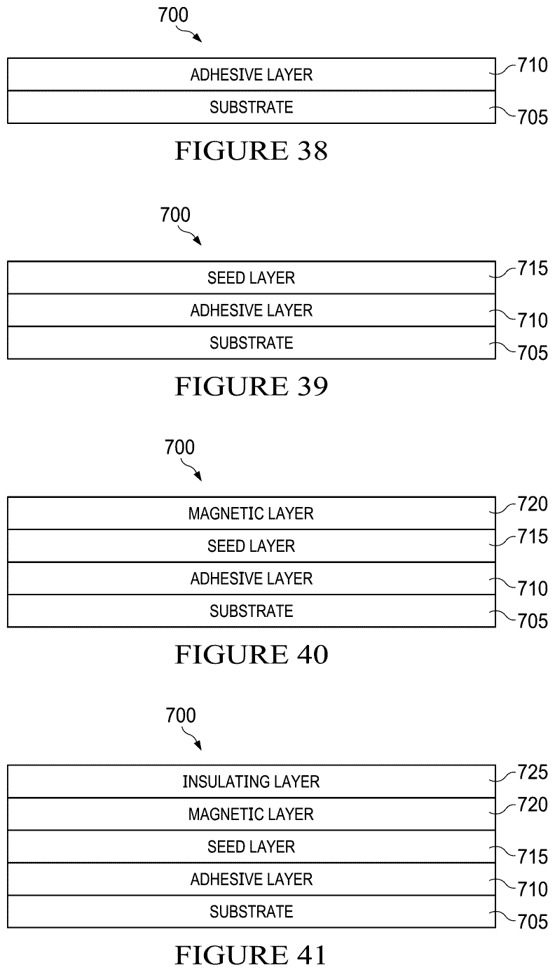

Turning now to FIGS. 38 to 49, illustrated are cross-sectional views of an embodiment of forming the micromagnetic device 700 of FIG. 37. Beginning with FIG. 38, the micromagnetic device 700 is constructed on a rigid or flexible substrate 705 such as silicon, glass, ceramic, molded polymer, flex or printed circuit board substrate, or other insulating material of approximately 0.1 to one (1) millimeter (“mm”) of thickness. A first adhesive layer 710 such as nickel, chromium, titanium, or titanium tungsten is deposited at about 100-600 angstroms (“Å”) of thickness on an upper surface of the substrate 705 employing a sputtering, evaporation, lamination, cladding, electroplating or electroless process.

Turning now to FIG. 39, a first seed layer 715 such as copper (or gold, titanium, titanium tungsten, nickel, nickel-iron, cobalt, ruthenium, platinum or titanium followed by a thin layer of copper or gold) is deposited on to the first adhesive layer 710 employing a sputtering, evaporation, lamination, cladding, electroplating or electroless process for a later electroplating step. The first seed layer 715 forms a conductive layer onto which a first magnetic layer 720 will be deposited in a following processing step. The thickness of the first seed layer 715 is in the range 1000-4000 Å preferably about 1500 Å. The first seed layer 715 may include multiple layers of like or different materials that can serve as a seed layer. Of course, other layers described herein may also include multiple layers of like or different materials that can serve the purpose of the respective layer.

Turning now to FIG. 40, a first magnetic layer 720 is deposited by a wet-bath electroplating process on the first seed layer 715. The first magnetic layer 720 includes boron in addition to iron, cobalt and phosphorous. The thickness of the first magnetic layer 720 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product.

Regarding the first magnetic layer 720, to provide an alloy with magnetic properties improved over alloys currently available, the quaternary alloy including iron, cobalt, boron and phosphorous is introduced. The first magnetic layer 720 includes cobalt in the range of 1.0-8.0 atomic percent, boron in the range of 0.5-10 atomic percent, and iron in the range of 70-95 atomic percent. The first magnetic layer 720 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the first magnetic layer 720 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

Turning now to FIG. 41, a first insulating layer 725 is deposited on the first magnetic layer 720. The first insulating layer 725 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the first insulating layer 725 is about, but not limited to, 0.02 to 5 microns (“μm”).

The thickness of the first insulating layer 725 can affect residual mechanical stress in the product due to differential thermal expansion of conductive, magnetic, and other layers during device processing steps. The thickness of the first insulating layer 725 can be adjusted using simulation or experimental techniques to produce a die with low residual mechanical stress after completion of micromagnetic device processing.

The first insulating layer 725 can be formed with a deposition of a patternable layer (e.g., photosensitive photoresist, screen printed polymer or laser patternable coating with no or very low electric conductivity) on top of the first magnetic layer 720, which is then hard cured by heating or other means. The first insulating layer 725 can be a semi-insulating layer such as polypyrrole with a low level of electrical conductivity deposited by an electroplating process. Following electroplating, the first insulating layer 725 is cured and annealed, which substantially reduces its conductivity. The result is a sufficiently high level of resistivity is obtained for a first insulating layer 725 in the micromagnetic device 700, thereby simplifying the total manufacturing process.

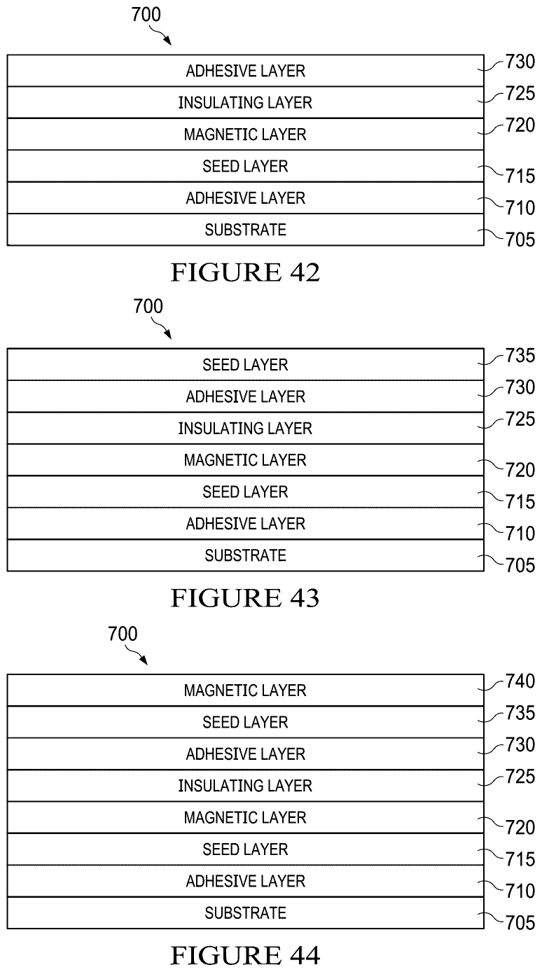

Turning now to FIG. 42, a second adhesive layer 730 such as nickel, chromium, titanium, or titanium tungsten is deposited at about 100-600 angstroms (“Å”) of thickness over the first insulating layer 725 employing a sputtering, evaporation, lamination, cladding, electroplating or electroless process.

Turning now to FIG. 43, a second seed layer 735 such as copper (or gold, titanium, titanium tungsten, nickel, nickel-iron, cobalt, ruthenium, platinum or titanium followed by a thin layer of copper or gold) is deposited on to the second adhesive layer 730 employing a sputtering, evaporation, lamination, cladding, electroplating or electroless process for a later electroplating step. The second seed layer 735 forms a conductive layer onto which a second magnetic layer 740 will be deposited in a following processing step. The thickness of the second seed layer 735 is in the range 1000-4000 Å preferably about 1500 Å. The second seed layer 735 may include multiple layers of like or different materials that can serve as a seed layer. Of course, other layers described herein may also include multiple layers of like or different materials that can serve the purpose of the respective layer.

Turning now to FIG. 44, a second magnetic layer 740 is deposited by a wet-bath electroplating process on the second seed layer 735. The second magnetic layer 740 includes boron in addition to iron, cobalt and phosphorous. The thickness of the second magnetic layer 740 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product.

Regarding the second magnetic layer 740, to provide an alloy with magnetic properties improved over alloys currently available, the quaternary alloy including iron, cobalt, boron and phosphorous is introduced. The second magnetic layer 740 includes cobalt in the range of 1.0-8.0 atomic percent, boron in the range of 0.5-10 atomic percent, and iron in the range of 70-95 atomic percent. The second magnetic layer 740 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the second magnetic layer 740 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

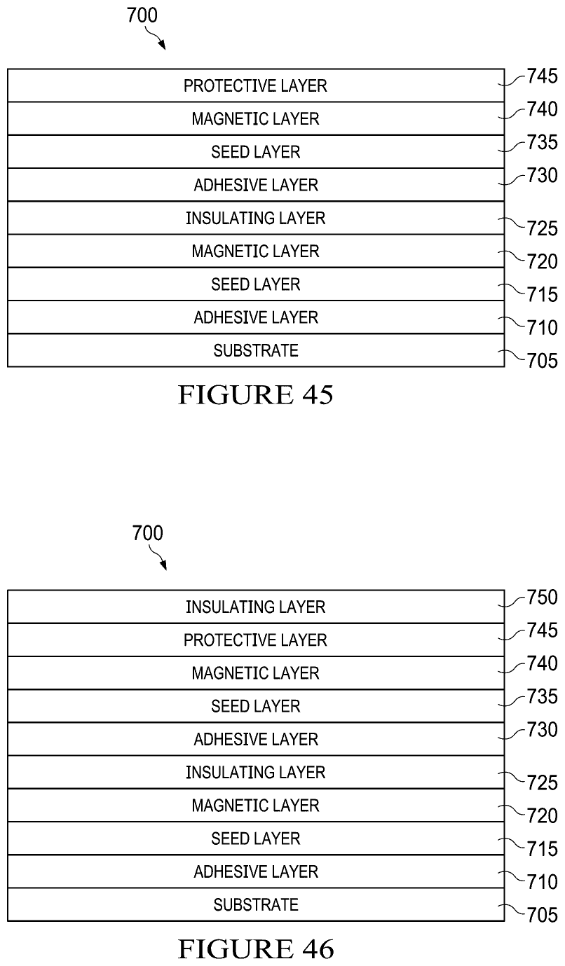

Turning now to FIG. 45, a protective layer 745 such as titanium, titanium tungsten (“TiW”), chromium or nickel (or nickel-based) is deposited at about 100-1000 Å of thickness on an upper surface of the second magnetic layer 740 employing a dry deposition, electroless or electroplating process. In accordance with the electroplating process, the micromagnetic device 700 is rinsed with carbon dioxide (“CO₂”)-saturated, de-ionized water and then immersed in an aqueous electrolyte (e.g., a titanium tungsten aqueous electrolyte) to form the protective layer 745 over the second magnetic layer 740.

Turning now to FIG. 46, a second insulating layer 750 is deposited on the protective layer 745. The second insulating layer 750 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the second insulating layer 750 is about, but not limited to, 0.02 to 5 microns (“μm”).

The thickness of the second insulating layer 750 can affect residual mechanical stress in the product due to differential thermal expansion of conductive, magnetic, and other layers during device processing steps. The thickness of the second insulating layer 750 can be adjusted using simulation or experimental techniques to produce a die with low residual mechanical stress after completion of micromagnetic device processing.

The second insulating layer 750 can be formed with a deposition of a patternable layer (e.g., photosensitive photoresist, screen printed polymer or laser patternable coating with no or very low electric conductivity) on top of the protective layer 745, which is then hard cured by heating or other means. The second insulating layer 750 can be a semi-insulating layer such as polypyrrole with a low level of electrical conductivity deposited by an electroplating process. Following electroplating, the second insulating layer 750 is cured and annealed, which substantially reduces its conductivity. The result is a sufficiently high level of resistivity is obtained for a second insulating layer 750 in the micromagnetic device 700, thereby simplifying the total manufacturing process.

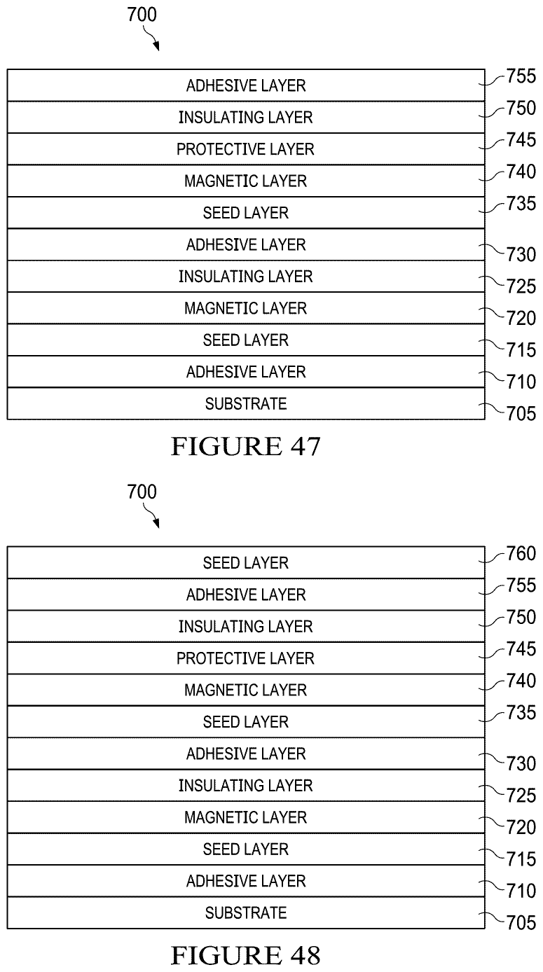

Turning now to FIG. 47, a third adhesive layer 755 such as nickel, chromium, titanium, or titanium tungsten is deposited at about 100-600 angstroms (“Å”) of thickness over the second insulating layer 750 employing a sputtering, evaporation, lamination, cladding, electroplating or electroless process.

Turning now to FIG. 48, a third seed layer 760 such as copper (or gold, titanium, titanium tungsten, nickel, nickel-iron, cobalt, ruthenium, platinum or titanium followed by a thin layer of copper or gold) is deposited on to the third adhesive layer 755 employing a sputtering, evaporation, lamination, cladding, electroplating or electroless process for a later electroplating step. The third seed layer 760 forms a conductive layer onto which a metallic layer 765 will be deposited in a following processing step. The thickness of the third seed layer 760 is in the range 1000-4000 Å preferably about 1500 Å. The third seed layer 760 may include multiple layers of like or different materials that can serve as a seed layer. Of course, other layers described herein may also include multiple layers of like or different materials that can serve the purpose of the respective layer.

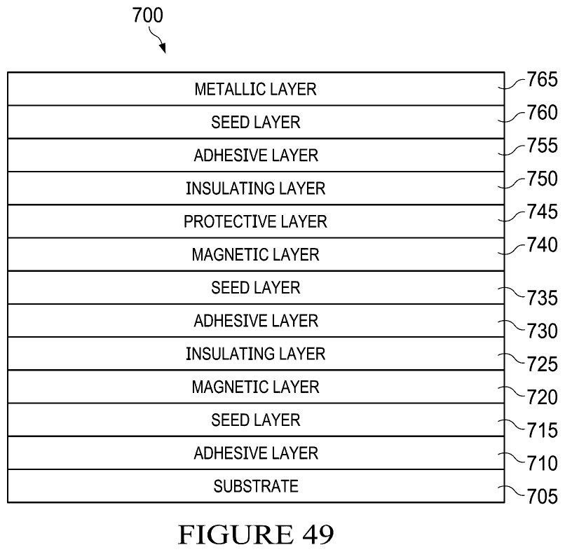

Turning now to FIG. 49, a metallic layer 765 is deposited by a wet-bath electroplating process on the third seed layer 760. The metallic layer 765 may be formed from copper, nickel, gold, aluminum, combination thereof (such as a stack of copper, nickel and gold) or other electrically conductive metallic material. The thickness of the metallic layer 765 is, without limitation, about 20 microns (“μm”).

Thus, a micromagnetic device formed with a quaternary alloy with magnetic properties improved over those currently available, and related method, has been introduced herein formed over a substrate. In an advantageous embodiment, the quaternary alloy includes iron, cobalt, boron and phosphorus, and is an amorphous or nanocrystalline magnetic alloy.

In an embodiment, the micromagnetic device (700) includes a substrate (705), a first adhesive layer (710) over the substrate (705), a first seed layer (715) over the first adhesive layer (710), and a first magnetic layer (720, e.g., one to fifteen microns in thickness) over the first seed layer (7150 from a magnetic alloy including iron, cobalt, boron and phosphorous. A content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion (e.g., 70-95 atomic percent) of the magnetic alloy. The micromagnetic device (700) includes a second magnetic layer (740) analogous to and above the first magnetic layer (720) and a metallic layer (765) over the second magnetic layer (740). The metallic layer (765) may be about 20 microns thick formed from copper, gold, aluminum, or other electrically conductive metallic material.

The magnetic alloy may also include at least one of sulfur, vanadium, chromium, rhodium, ruthenium, carbon, tin, bismuth, tungsten, and copper with a concentration in a range of 1 to 1000 parts per million. The magnetic alloy is an amorphous or nanocrystalline magnetic alloy.

The micromagnetic device (700) also includes a first insulting layer (725), a second adhesive layer (730) and a second seed layer (735) between the first magnetic layer (725) and the second magnetic layer (740). The micromagnetic device (700) also includes a protective layer (745), a second insulating layer (750), a third adhesive layer (755) and a third seed layer (760) between the second magnetic layer (740) and the metallic layer (765). The first, second and third adhesive layers (710, 730, 755) may include at least one of nickel, chromium, titanium, and titanium tungsten.

The first, second and third seed layers (715, 735, 760) may include at least one of copper, gold, titanium, titanium tungsten, nickel, nickel-iron, cobalt, ruthenium, platinum and titanium followed by a thin layer of copper or gold. The first, second and third seed layers (715, 735, 760) form a conductive layer onto which the first and second magnetic layers (720, 740) and the metallic layer (765) are formed. The first and second insulating layers (725, 750, e.g., a polymer, an aluminum oxide or silicon dioxide) can affect residual mechanical stress in the product due to differential thermal expansion of conductive, magnetic, and other layers during device processing steps. The protective layer (745) may include at least one of titanium, titanium tungsten, chromium, and nickel.

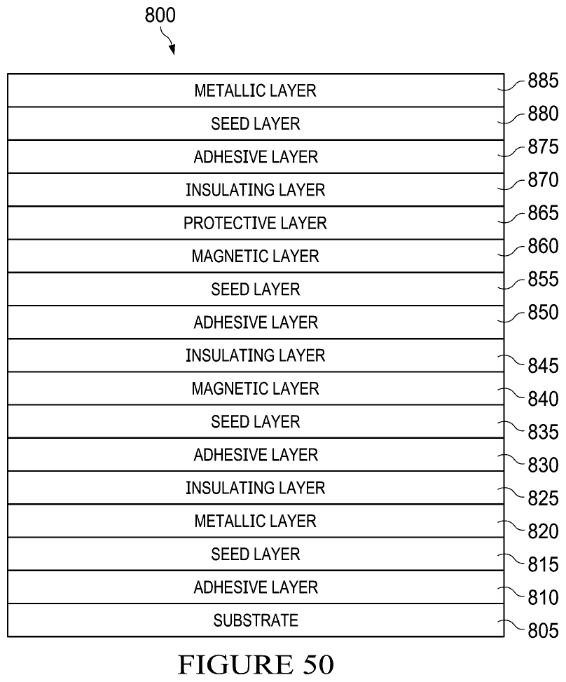

Turning now to FIG. 50, illustrated is a cross-sectional view of an embodiment of a micromagnetic device 800. The micromagnetic device 800 is formed on a substrate 805 with a first adhesive layer 810 formed thereover. A first seed layer 815 is formed over the first adhesive layer 810, and a first metallic layer 820 is formed over the first seed layer 815. A first insulating layer 825 is formed over the first metallic layer 820, and a second adhesive layer 830 is formed over the first insulating layer 825. A second seed layer 835 is formed over the second adhesive layer 830, and a first magnetic layer 840 is formed over the second seed layer 835. A second insulating layer 845 is formed over the first magnetic layer 840, and a third adhesive layer 850 is formed over the second insulating layer 845. A third seed layer 855 is formed over the third adhesive layer 850, and a second magnetic layer 860 is formed over the third seed layer 855. A protective layer 865 is formed over the second magnetic layer 860, and a third insulating layer 870 is formed over the protective layer 865. A fourth adhesive layer 875 is formed over the third insulating layer 870, a fourth seed layer 880 is formed over the fourth adhesive layer 875, and a second metallic layer 885 is formed over the fourth seed layer 880.

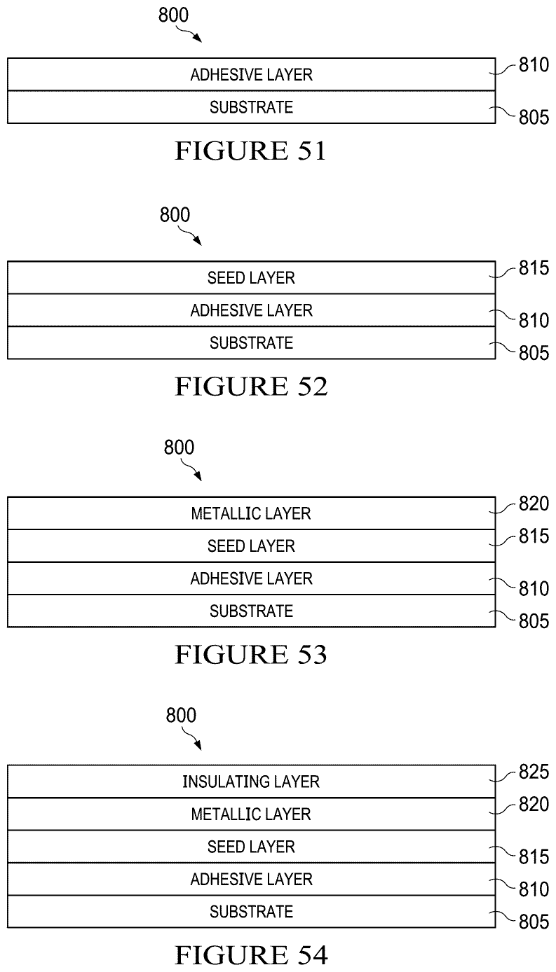

Turning now to FIGS. 51 to 66, illustrated are cross-sectional views of an embodiment of forming the micromagnetic device 800 of FIG. 50. Beginning with FIG. 51, the micromagnetic device 800 is constructed on a rigid or flexible substrate 805 such as silicon, glass, ceramic, molded polymer, flex or printed circuit board substrate, or other insulating material of approximately 0.1 to one (1) millimeter (“mm”) of thickness. A first adhesive layer 810 such as nickel, chromium, titanium, or titanium tungsten is deposited at about 100-600 angstroms (“Å”) of thickness on an upper surface of the substrate 805 employing a sputtering, evaporation, lamination, cladding, electroplating or electroless process.

Turning now to FIG. 52, a first seed layer 815 such as copper (or gold, titanium, titanium tungsten, nickel, nickel-iron, cobalt, ruthenium, platinum or titanium followed by a thin layer of copper or gold) is deposited on to the first adhesive layer 810 employing a sputtering, evaporation, lamination, cladding, electroplating or electroless process for a later electroplating step. The first seed layer 815 forms a conductive layer onto which a first metallic layer 820 will be deposited in a following processing step. The thickness of the first seed layer 815 is in the range 1000-4000 Å preferably about 1500 Å. The first seed layer 815 may include multiple layers of like or different materials that can serve as a seed layer. Of course, other layers described herein may also include multiple layers of like or different materials that can serve the purpose of the respective layer.

Turning now to FIG. 53, the first metallic layer 820 is deposited by a wet-bath electroplating process on the first seed layer 815. The first metallic layer 820 may be formed from copper, nickel, gold, aluminum, combination thereof (such as a stack of copper, nickel and gold) or other electrically conductive metallic material. The thickness of the first metallic layer 820 is, without limitation, about 20 microns (“μm”).

Turning now to FIG. 54, a first insulating layer 825 is deposited on the first metallic layer 820. The first insulating layer 825 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the first insulating layer 825 is about, but not limited to, 0.02 to 5 microns (“μm”).

The thickness of the first insulating layer 825 can affect residual mechanical stress in the product due to differential thermal expansion of conductive, magnetic, and other layers during device processing steps. The thickness of the first insulating layer 825 can be adjusted using simulation or experimental techniques to produce a die with low residual mechanical stress after completion of micromagnetic device processing.

The first insulating layer 825 can be formed with a deposition of a patternable layer (e.g., photosensitive photoresist, screen printed polymer or laser patternable coating with no or very low electric conductivity) on top of the first metallic layer 820, which is then hard cured by heating or other means. The first insulating layer 825 can be a semi-insulating layer such as polypyrrole with a low level of electrical conductivity deposited by an electroplating process. Following electroplating, the first insulating layer 825 is cured and annealed, which substantially reduces its conductivity. The result is a sufficiently high level of resistivity is obtained for the first insulating layer 825 in the micromagnetic device 800, thereby simplifying the total manufacturing process.

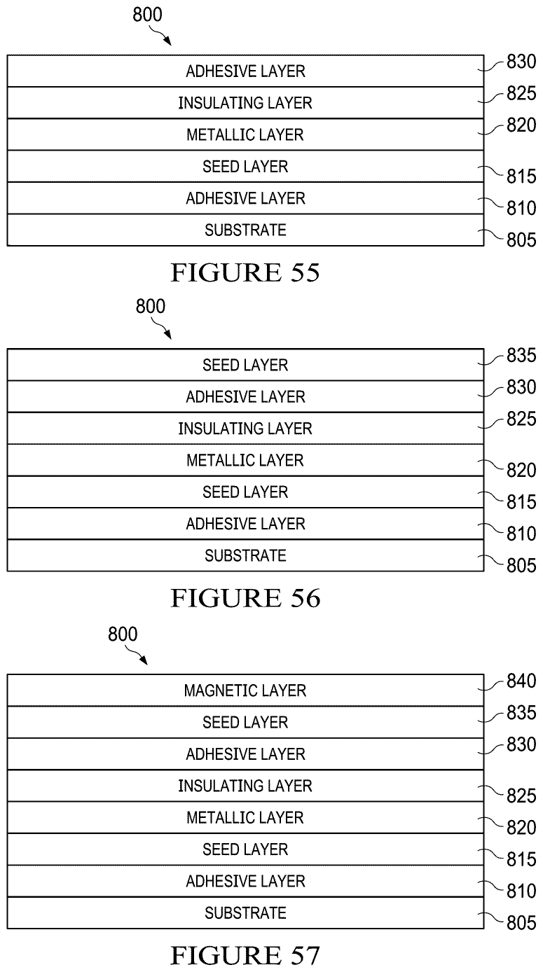

Turning now to FIG. 55, a second adhesive layer 830 such as nickel, chromium, titanium, or titanium tungsten is deposited at about 100-600 angstroms (“Å”) of thickness over the first insulating layer 825 employing a sputtering, evaporation, lamination, cladding, electroplating or electroless process.

Turning now to FIG. 56, a second seed layer 835 such as copper (or gold, titanium, titanium tungsten, nickel, nickel-iron, cobalt, ruthenium, platinum or titanium followed by a thin layer of copper or gold) is deposited on to the second adhesive layer 830 employing a sputtering, evaporation, lamination, cladding, electroplating or electroless process for a later electroplating step. The second seed layer 835 forms a conductive layer onto which a first magnetic layer 840 will be deposited in a following processing step. The thickness of the second seed layer 835 is in the range 1000-4000 Å preferably about 1500 Å. The second seed layer 835 may include multiple layers of like or different materials that can serve as a seed layer. Of course, other layers described herein may also include multiple layers of like or different materials that can serve the purpose of the respective layer.

Turning now to FIG. 57, a first magnetic layer 840 is deposited by a wet-bath electroplating process on the second seed layer 835. The first magnetic layer 840 includes boron in addition to iron, cobalt and phosphorous. The thickness of the first magnetic layer 840 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product.

Regarding the first magnetic layer 840, to provide an alloy with magnetic properties improved over alloys currently available, the quaternary alloy including iron, cobalt, boron and phosphorous is introduced. The first magnetic layer 840 includes cobalt in the range of 1.0-8.0 atomic percent, boron in the range of 0.5-10 atomic percent, and iron in the range of 70-95 atomic percent. The first magnetic layer 840 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the first magnetic layer 840 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

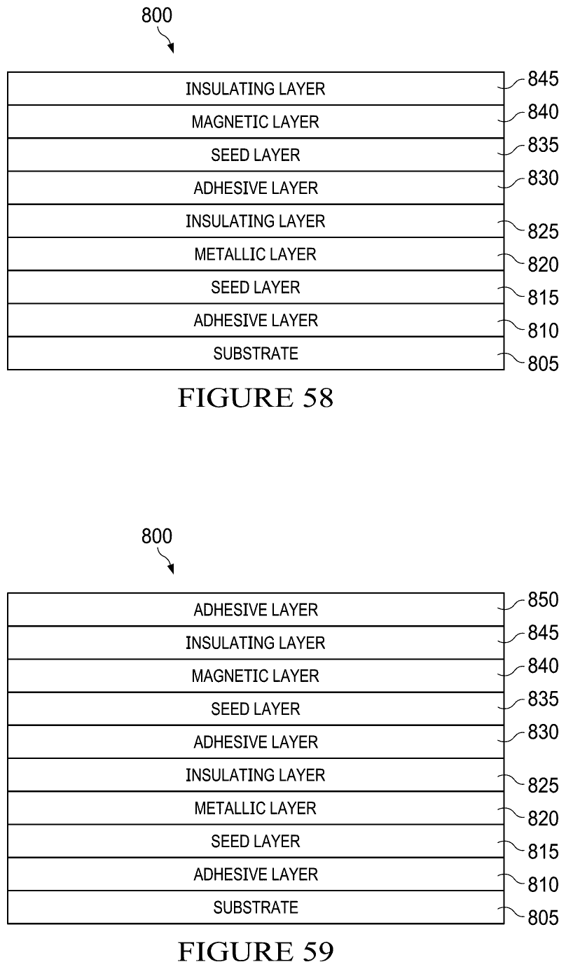

Turning now to FIG. 58, a second insulating layer 845 is deposited on the first magnetic layer 840. The second insulating layer 845 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the second insulating layer 845 is about, but not limited to, 0.02 to 5 microns (“μm”).

The thickness of the second insulating layer 845 can affect residual mechanical stress in the product due to differential thermal expansion of conductive, magnetic, and other layers during device processing steps. The thickness of the second insulating layer 845 can be adjusted using simulation or experimental techniques to produce a die with low residual mechanical stress after completion of micromagnetic device processing.

The second insulating layer 845 can be formed with a deposition of a patternable layer (e.g., photosensitive photoresist, screen printed polymer or laser patternable coating with no or very low electric conductivity) on top of the first magnetic layer 840, which is then hard cured by heating or other means. The second insulating layer 845 can be a semi-insulating layer such as polypyrrole with a low level of electrical conductivity deposited by an electroplating process. Following electroplating, the second insulating layer 845 is cured and annealed, which substantially reduces its conductivity. The result is a sufficiently high level of resistivity is obtained for the second insulating layer 845 in the micromagnetic device 800, thereby simplifying the total manufacturing process.

Turning now to FIG. 59, a third adhesive layer 850 such as nickel, chromium, titanium, or titanium tungsten is deposited at about 100-600 angstroms (“Å”) of thickness over the second insulating layer 845 employing a sputtering, evaporation, lamination, cladding, electroplating or electroless process.

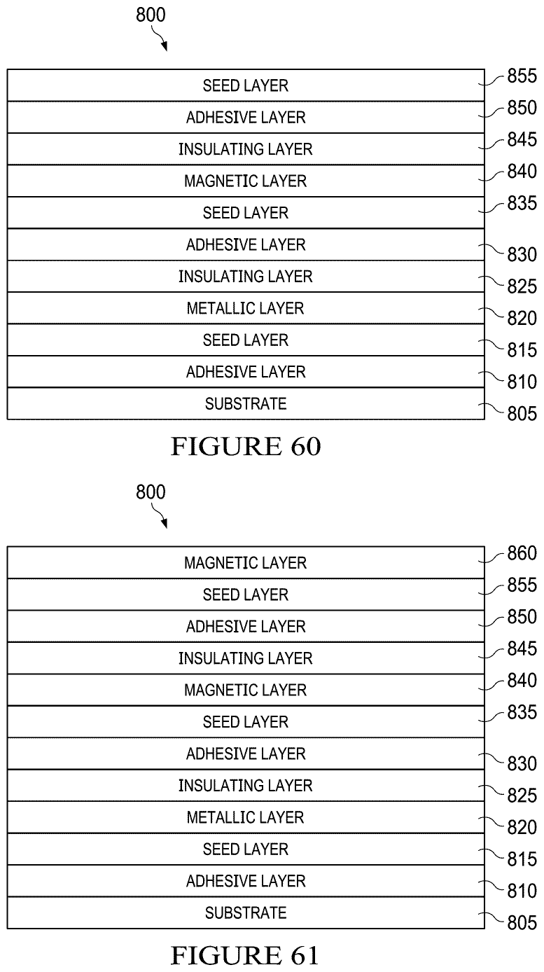

Turning now to FIG. 60, a third seed layer 855 such as copper (or gold, titanium, titanium tungsten, nickel, nickel-iron, cobalt, ruthenium, platinum or titanium followed by a thin layer of copper or gold) is deposited on to the third adhesive layer 850 employing a sputtering, evaporation, lamination, cladding, electroplating or electroless process for a later electroplating step. The third seed layer 855 forms a conductive layer onto which a second magnetic layer 860 will be deposited in a following processing step. The thickness of the third seed layer 855 is in the range 1000-4000 Å preferably about 1500 Å. The third seed layer 855 may include multiple layers of like or different materials that can serve as a seed layer. Of course, other layers described herein may also include multiple layers of like or different materials that can serve the purpose of the respective layer.

Turning now to FIG. 61, a second magnetic layer 860 is deposited by a wet-bath electroplating process on the third seed layer 855. The second magnetic layer 860 includes boron in addition to iron, cobalt and phosphorous, and may include analogous features to the first magnetic layer 820 described above.

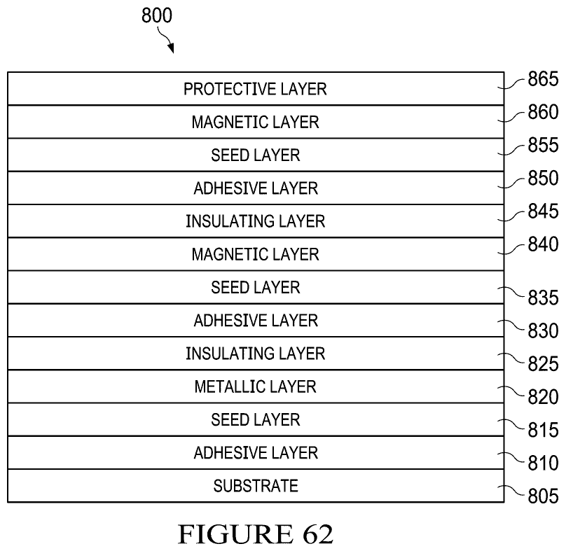

Turning now to FIG. 62, a protective layer 865 such as titanium, titanium tungsten (“TiW”), chromium or nickel (or nickel-based) is deposited at about 100-1000 Å of thickness on an upper surface of the second magnetic layer 860 employing a dry deposition, electroless or electroplating process. In accordance with the electroplating process, the micromagnetic device 800 is rinsed with carbon dioxide (“CO₂”)-saturated, de-ionized water and then immersed in an aqueous electrolyte (e.g., a titanium tungsten aqueous electrolyte) to form the protective layer 865 over the second magnetic layer 860.

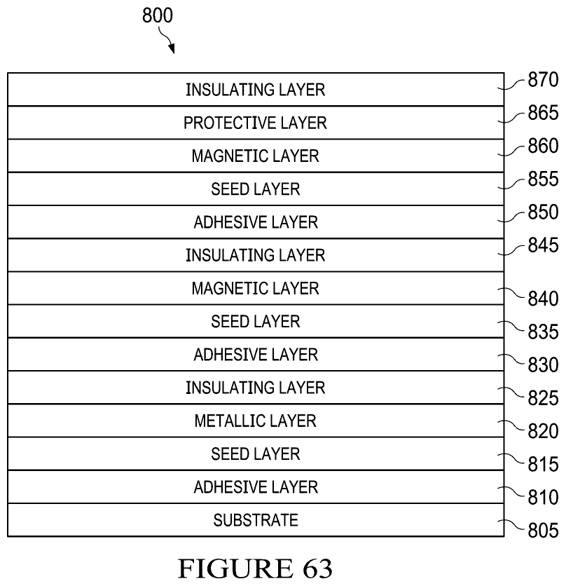

Turning now to FIG. 63, a third insulating layer 870 is deposited on the protective layer 865. The third insulating layer 870 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the third insulating layer 870 is about, but not limited to, 0.02 to 5 microns (“μm”).

The thickness of the third insulating layer 870 can affect residual mechanical stress in the product due to differential thermal expansion of conductive, magnetic, and other layers during device processing steps. The thickness of the third insulating layer 870 can be adjusted using simulation or experimental techniques to produce a die with low residual mechanical stress after completion of micromagnetic device processing.

The third insulating layer 870 can be formed with a deposition of a patternable layer (e.g., photosensitive photoresist, screen printed polymer or laser patternable coating with no or very low electric conductivity) on top of the protective layer 865, which is then hard cured by heating or other means. The third insulating layer 870 can be a semi-insulating layer such as polypyrrole with a low level of electrical conductivity deposited by an electroplating process. Following electroplating, the third insulating layer 870 is cured and annealed, which substantially reduces its conductivity. The result is a sufficiently high level of resistivity is obtained for a third insulating layer 870 in the micromagnetic device 800, thereby simplifying the total manufacturing process.

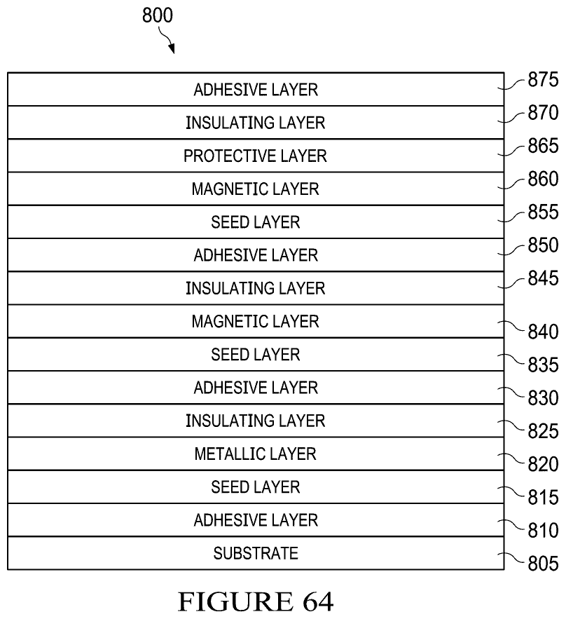

Turning now to FIG. 64, a fourth adhesive layer 875 such as nickel, chromium, titanium, or titanium tungsten is deposited at about 100-600 angstroms (“Å”) of thickness over the third insulating layer 870 employing a sputtering, evaporation, lamination, cladding, electroplating or electroless process.

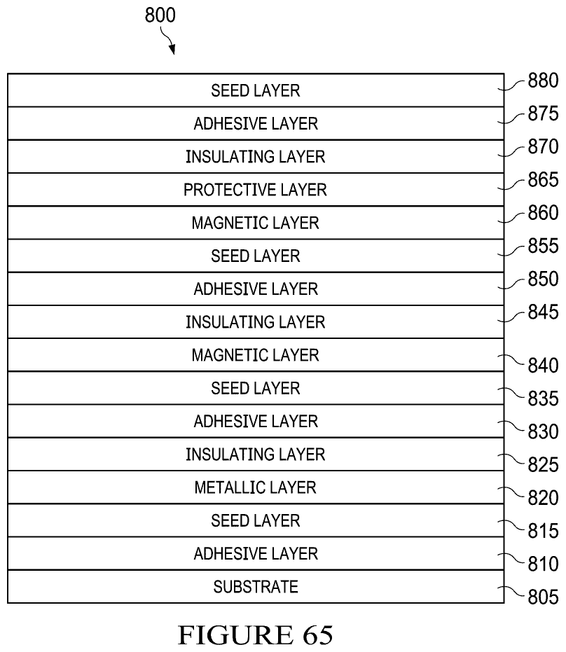

Turning now to FIG. 65, a fourth seed layer 880 such as copper (or gold, titanium, titanium tungsten, nickel, nickel-iron, cobalt, ruthenium, platinum or titanium followed by a thin layer of copper or gold) is deposited on to the fourth adhesive layer 875 employing a sputtering, evaporation, lamination, cladding, electroplating or electroless process for a later electroplating step. The fourth seed layer 880 forms a conductive layer onto which a second metallic layer 885 will be deposited in a following processing step. The thickness of the fourth seed layer 880 is in the range 1000-4000 Å preferably about 1500 Å. The fourth seed layer 880 may include multiple layers of like or different materials that can serve as a seed layer. Of course, other layers described herein may also include multiple layers of like or different materials that can serve the purpose of the respective layer.

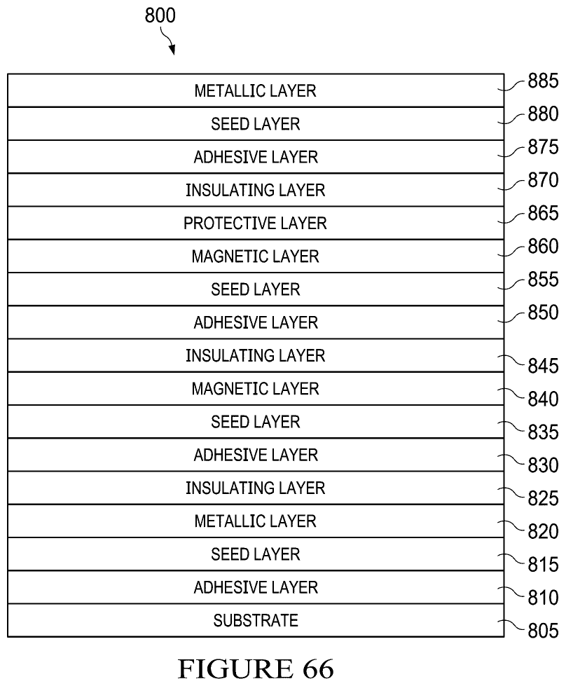

Turning now to FIG. 66, a second metallic layer 885 is deposited by a wet-bath electroplating process on the fourth seed layer 880. The second metallic layer 885 may be formed from copper, nickel, gold, aluminum, combination thereof (such as a stack of copper, nickel and gold) or other electrically conductive metallic material. The thickness of the second metallic layer 885 is, without limitation, about 20 microns (“μm”).

Thus, a micromagnetic device formed with a quaternary alloy with magnetic properties improved over those currently available, and related method, has been introduced herein formed over a substrate. In an advantageous embodiment, the quaternary alloy includes iron, cobalt, boron and phosphorus, and is an amorphous or nanocrystalline magnetic alloy.

In an embodiment, the micromagnetic device (800) includes a substrate (805), a first adhesive layer (810) over the substrate (805), a first seed layer (815) over the first adhesive layer (810), and a first metallic layer (820) over the first seed layer (815). The micromagnetic device (800) also includes first and second magnetic layers (840, 860, e.g., one to fifteen microns in thickness) over the first metallic layer (820) from a magnetic alloy including iron, cobalt, boron and phosphorous. A content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion (e.g., 70-95 atomic percent) of the magnetic alloy.

The magnetic alloy may also include at least one of sulfur, vanadium, chromium, rhodium, ruthenium, carbon, tin, bismuth, tungsten, and copper with a concentration in a range of 1 to 1000 parts per million. The magnetic alloy is an amorphous or nanocrystalline magnetic alloy.

The micromagnetic device (800) also includes a second metallic layer (885) over the second magnetic layer (860). The first and second metallic layers (820, 885) may be about 20 microns thick formed from copper, gold, aluminum, or other electrically conductive metallic material.

The micromagnetic device (800) also includes a first insulting layer (825), a second adhesive layer (830) and a second seed layer (835) between the first metallic layer (820) and the first magnetic layer (840). The micromagnetic device (800) also includes a second insulting layer (845), a third adhesive layer (850) and a third seed layer (855) between the first magnetic layer (840) and the second magnetic layer (860). The micromagnetic device (800) also includes a protective layer (865), a third insulting layer (870), a fourth adhesive layer (875) and a fourth seed layer (880) between the second magnetic layer (860) and the second metallic layer (885). The first, second, third and fourth adhesive layers (810, 830, 850, 875) may include at least one of nickel, chromium, titanium, and titanium tungsten.

The first, second, third and fourth seed layers (815, 835, 855, 880) may include at least one of copper, gold, titanium, titanium tungsten, nickel, nickel-iron, cobalt, ruthenium, platinum and titanium followed by a thin layer of copper or gold. The first, second, third and fourth seed layers (815, 835, 855, 880) form a conductive layer onto which the first and second magnetic layers (840, 860) and the first and second metallic layers (820, 885) are formed. The first, second and third insulating layers (825, 845, 870, e.g., a polymer, an aluminum oxide or silicon dioxide) can affect residual mechanical stress in the product due to differential thermal expansion of conductive, magnetic, and other layers during device processing steps. The protective layer (865) may include at least one of titanium, titanium tungsten, chromium, and nickel.

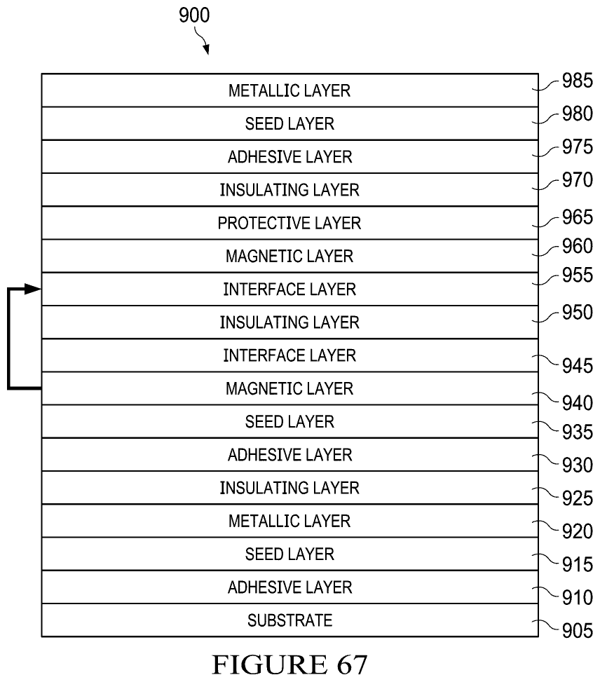

Turning now to FIG. 67, illustrated is a cross-sectional view of an embodiment of a micromagnetic device 900. The micromagnetic device 900 is formed on a substrate 905 with a first adhesive layer 910 formed thereover. A first seed layer 915 is formed over the first adhesive layer 910, and a first metallic layer 920 is formed over the first seed layer 915. A first insulating layer 925 is formed over the first metallic layer 920, and a second adhesive layer 930 is formed over the first insulating layer 925. A second seed layer 935 is formed over the second adhesive layer 930, and a first magnetic layer 940 is formed over the second seed layer 935. A first interface layer 945 is formed over the first magnetic layer 940, a second insulating layer 950 is formed over the first interface layer 945, and a second interface layer 955 is formed over the second insulating layer 950. A second magnetic layer 960 is formed over the second interface layer 955, a protective layer 965 is formed over the second magnetic layer 960, and a third insulating layer 970 is formed over the protective layer 965. A third adhesive layer 975 is formed over the third insulating layer 970, a third seed layer 980 is formed over the third adhesive layer 975, and a second metallic layer 985 is formed over the third seed layer 980.

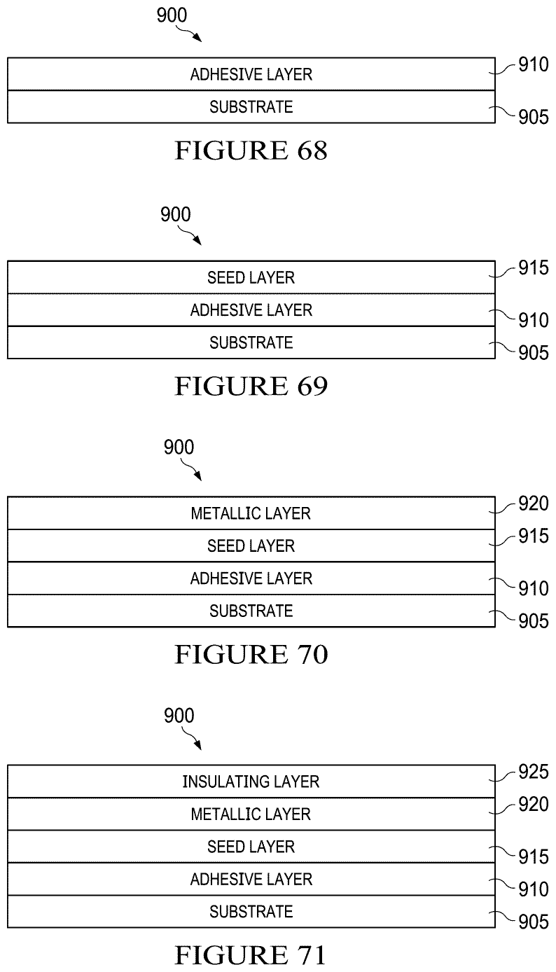

Turning now to FIGS. 68 to 83, illustrated are cross-sectional views of an embodiment of forming the micromagnetic device 900 of FIG. 67. Beginning with FIG. 68, the micromagnetic device 900 is constructed on a rigid or flexible substrate 905 such as silicon, glass, ceramic, molded polymer, flex or printed circuit board substrate, or other insulating material of approximately 0.1 to one (1) millimeter (“mm”) of thickness. A first adhesive layer 910 such as nickel, chromium, titanium, or titanium tungsten is deposited at about 100-600 angstroms (“Å”) of thickness on an upper surface of the substrate 905 employing a sputtering, evaporation, lamination, cladding, electroplating or electroless process.

Turning now to FIG. 69, a first seed layer 915 such as copper (or gold, titanium, titanium tungsten, nickel, nickel-iron, cobalt, ruthenium, platinum or titanium followed by a thin layer of copper or gold) is deposited on to the first adhesive layer 910 employing a sputtering, evaporation, lamination, cladding, electroplating or electroless process for a later electroplating step. The first seed layer 915 forms a conductive layer onto which a first metallic layer 920 will be deposited in a following processing step. The thickness of the first seed layer 915 is in the range 1000-4000 Å preferably about 1500 Å. The first seed layer 915 may include multiple layers of like or different materials that can serve as a seed layer. Of course, other layers described herein may also include multiple layers of like or different materials that can serve the purpose of the respective layer.

Turning now to FIG. 70, the first metallic layer 920 is deposited by a wet-bath electroplating process on the first seed layer 915. The first metallic layer 920 may be formed from copper, nickel, gold, aluminum, combination thereof (such as a stack of copper, nickel and gold) or other electrically conductive metallic material. The thickness of the first metallic layer 920 is, without limitation, about 20 microns (“μm”).

Turning now to FIG. 71, a first insulating layer 925 is deposited on the first metallic layer 920. The first insulating layer 925 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the first insulating layer 925 is about, but not limited to, 0.02 to 5 microns (“μm”).

The thickness of the first insulating layer 925 can affect residual mechanical stress in the product due to differential thermal expansion of conductive, magnetic, and other layers during device processing steps. The thickness of the first insulating layer 925 can be adjusted using simulation or experimental techniques to produce a die with low residual mechanical stress after completion of micromagnetic device processing.

The first insulating layer 925 can be formed with a deposition of a patternable layer (e.g., photosensitive photoresist, screen printed polymer or laser patternable coating with no or very low electric conductivity) on top of the first metallic layer 920, which is then hard cured by heating or other means. The first insulating layer 925 can be a semi-insulating layer such as polypyrrole with a low level of electrical conductivity deposited by an electroplating process. Following electroplating, the first insulating layer 925 is cured and annealed, which substantially reduces its conductivity. The result is a sufficiently high level of resistivity is obtained for the first insulating layer 925 in the micromagnetic device 900, thereby simplifying the total manufacturing process.

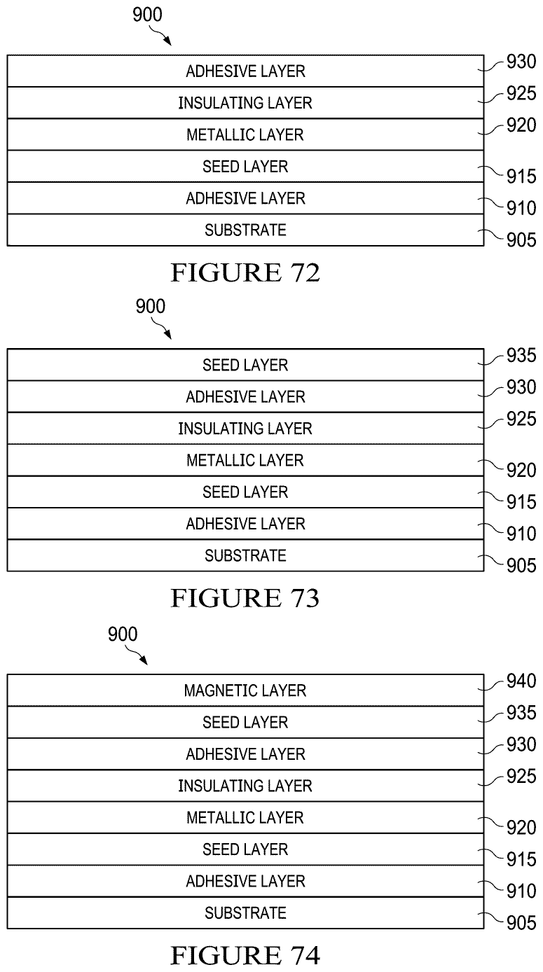

Turning now to FIG. 72, a second adhesive layer 930 such as nickel, chromium, titanium, or titanium tungsten is deposited at about 100-600 angstroms (“Å”) of thickness over the first insulating layer 925 employing a sputtering, evaporation, lamination, cladding, electroplating or electroless process.

Turning now to FIG. 73, a second seed layer 935 such as copper (or gold, titanium, titanium tungsten, nickel, nickel-iron, cobalt, ruthenium, platinum or titanium followed by a thin layer of copper or gold) is deposited on to the second adhesive layer 930 employing a sputtering, evaporation, lamination, cladding, electroplating or electroless process for a later electroplating step. The second seed layer 935 forms a conductive layer onto which a first magnetic layer 940 will be deposited in a following processing step. The thickness of the second seed layer 935 is in the range 1000-4000 Å preferably about 1500 Å. The second seed layer 935 may include multiple layers of like or different materials that can serve as a seed layer. Of course, other layers described herein may also include multiple layers of like or different materials that can serve the purpose of the respective layer.

Turning now to FIG. 74, a first magnetic layer 940 is deposited by a wet-bath electroplating process on the second seed layer 935. The first magnetic layer 940 includes boron in addition to iron, cobalt and phosphorous. The thickness of the first magnetic layer 940 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product.

Regarding the first magnetic layer 940, to provide an alloy with magnetic properties improved over alloys currently available, the quaternary alloy including iron, cobalt, boron and phosphorous is introduced. The first magnetic layer 940 includes cobalt in the range of 1.0-8.0 atomic percent, boron in the range of 0.5-10 atomic percent, and iron in the range of 70-95 atomic percent. The first magnetic layer 940 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the first magnetic layer 940 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

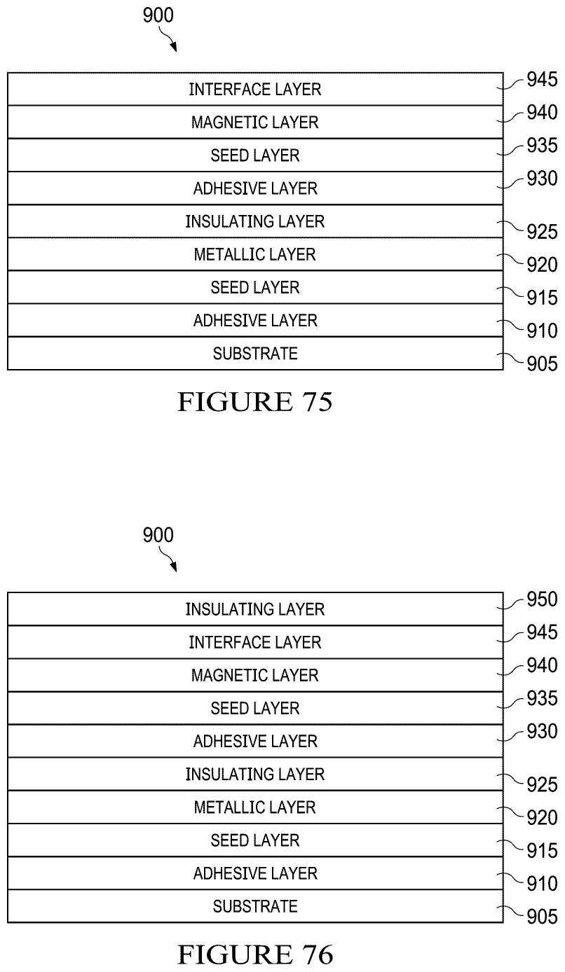

Turning now to FIG. 75, a first interface layer 945 is deposited on the first magnetic layer 940. The first interface layer 945 is used to enhance the integration of an insulting layer (e.g., the second insulating layer 950) such as a semi-insulating layer (e.g., hard baked photoresist or polypyrrole) with a low level of electrical conductivity when deposited by an electroplating process. The first interface layer 945 may be, without limitation, gold, nickel, nickel-iron, cobalt or molybdenum or a combination of consecutive layers of the above and is deposited by employing an electroplating or electroless process. The thickness of the interface layer 945 is in the range 100 Å-5000 Å preferably about 200 Å.

Turning now to FIG. 76, the second insulating layer 950 is deposited on the first interface layer 945. The second insulating layer 950 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the insulating layer 450 is about, but not limited to, 0.02 to 5 microns (“μm”).

The thickness of the second insulating layer 950 can affect residual mechanical stress in the product due to differential thermal expansion of conductive, magnetic, and other layers during device processing steps. The thickness of the second insulating layer 950 can be adjusted using simulation or experimental techniques to produce a die with low residual mechanical stress after completion of micromagnetic device processing.

The second insulating layer 950 can be formed with a deposition of a patternable layer (e.g., photosensitive photoresist, screen printed polymer or laser patternable coating with no or very low electric conductivity) on top of the first interface layer 945, which is then hard cured by heating or other means. The second insulating layer 950 can be a semi-insulating layer such as polypyrrole with a low level of electrical conductivity deposited by an electroplating process. Following electroplating, the second insulating layer 950 is cured and annealed, which substantially reduces its conductivity. The result is a sufficiently high level of resistivity is obtained for the second insulating layer 950 in the micromagnetic device 900, thereby simplifying the total manufacturing process.

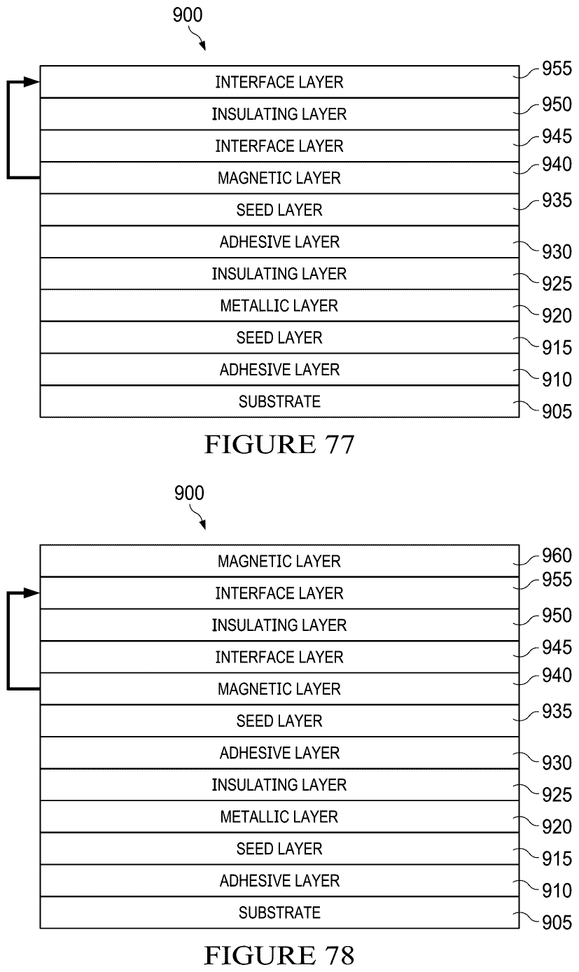

Turning now to FIG. 77, a second interface layer 955 is deposited on the second insulating layer 950. The second interface layer 955 may include analogous features to the first interface layer 945 described above. The arrow indicates that the intervening interface layers 945, 955, and insulating layer 950 can be repeated depending on the number of magnetic layers. It should be understood that the same principle applies to the other micromagnetic devices disclosed herein. In other words, multiple magnetic layers with the corresponding intervening and surrounding layers may be incorporated into any of the micromagnetic devices disclosed herein. Other layers such as the metallic layers may be repeated as well.

Turning now to FIG. 78, a second magnetic layer 960 is deposited by a wet-bath electroplating process on the second interface layer 955. The second magnetic layer 960 includes boron in addition to iron, cobalt and phosphorous, and may include analogous features to the first magnetic layer 940 described above.

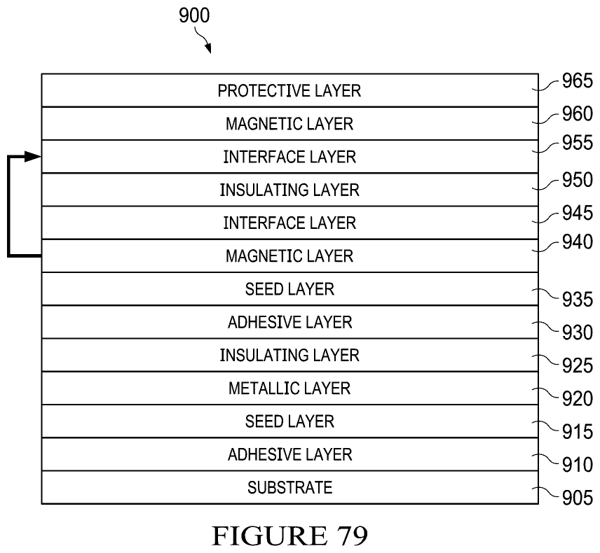

Turning now to FIG. 79, a protective layer 965 such as titanium, titanium tungsten (“TiW”), chromium or nickel (or nickel-based) is deposited at about 100-1000 Å of thickness on the second magnetic layer 960 employing a dry deposition, electroless or electroplating process. In accordance with the electroplating process, the micromagnetic device 900 is rinsed with carbon dioxide (“CO₂”)-saturated, de-ionized water and then immersed in an aqueous electrolyte (e.g., a titanium tungsten aqueous electrolyte) to form the protective layer 965 over the second magnetic layer 960.

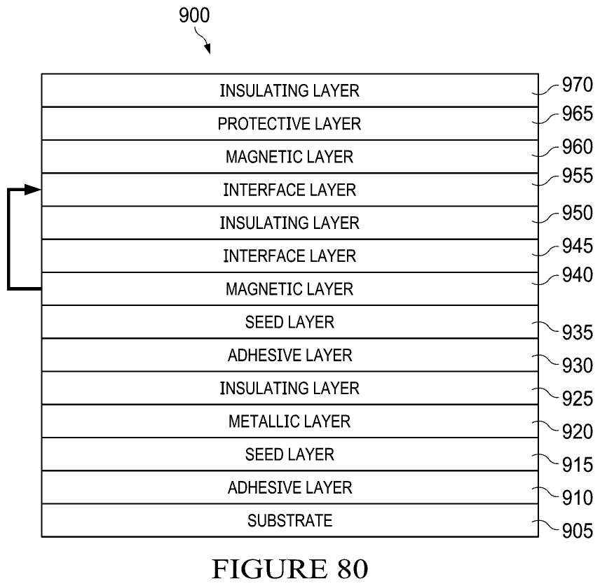

Turning now to FIG. 80, a third insulating layer 970 is deposited on the protective layer 965. The third insulating layer 970 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the third insulating layer 970 is about, but not limited to, 0.02 to 5 microns (“μm”).

The thickness of the third insulating layer 970 can affect residual mechanical stress in the product due to differential thermal expansion of conductive, magnetic, and other layers during device processing steps. The thickness of the third insulating layer 970 can be adjusted using simulation or experimental techniques to produce a die with low residual mechanical stress after completion of micromagnetic device processing.

The third insulating layer 970 can be formed with a deposition of a patternable layer (e.g., photosensitive photoresist, screen printed polymer or laser patternable coating with no or very low electric conductivity) on top of the protective layer 965, which is then hard cured by heating or other means. The third insulating layer 970 can be a semi-insulating layer such as polypyrrole with a low level of electrical conductivity deposited by an electroplating process. Following electroplating, the third insulating layer 970 is cured and annealed, which substantially reduces its conductivity. The result is a sufficiently high level of resistivity is obtained for a third insulating layer 970 in the micromagnetic device 900, thereby simplifying the total manufacturing process.

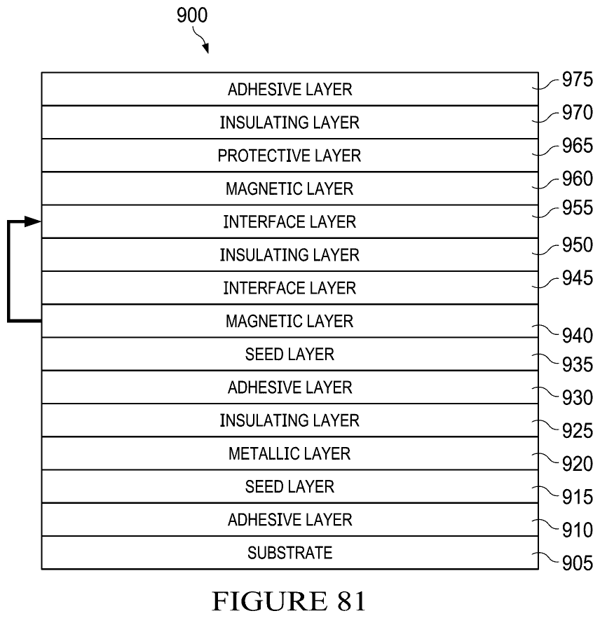

Turning now to FIG. 81, a third adhesive layer 975 such as nickel, chromium, titanium, or titanium tungsten is deposited at about 100-600 angstroms (“Å”) of thickness over the third insulating layer 970 employing a sputtering, evaporation, lamination, cladding, electroplating or electroless process.

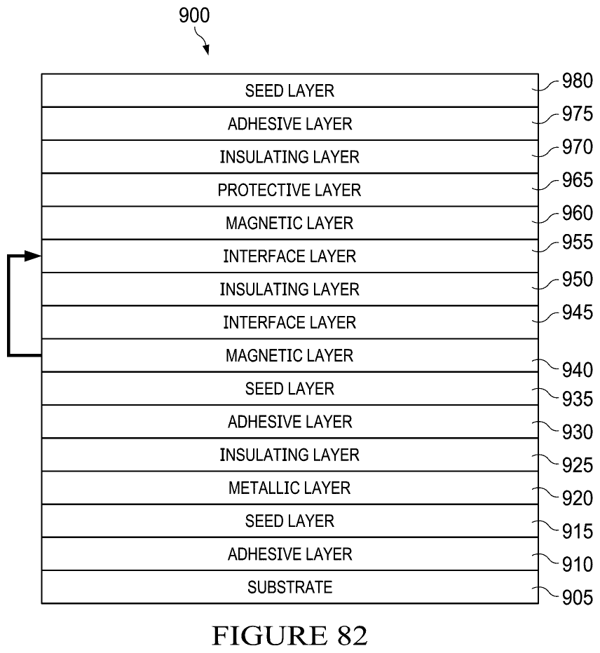

Turning now to FIG. 82, a third seed layer 980 such as copper (or gold, titanium, titanium tungsten, nickel, nickel-iron, cobalt, ruthenium, platinum or titanium followed by a thin layer of copper or gold) is deposited on to the third adhesive layer 975 employing a sputtering, evaporation, lamination, cladding, electroplating or electroless process for a later electroplating step. The third seed layer 980 forms a conductive layer onto which a second metallic layer 985 will be deposited in a following processing step. The thickness of the third seed layer 980 is in the range 1000-4000 Å preferably about 1500 Å. The third seed layer 980 may include multiple layers of like or different materials that can serve as a seed layer. Of course, other layers described herein may also include multiple layers of like or different materials that can serve the purpose of the respective layer.

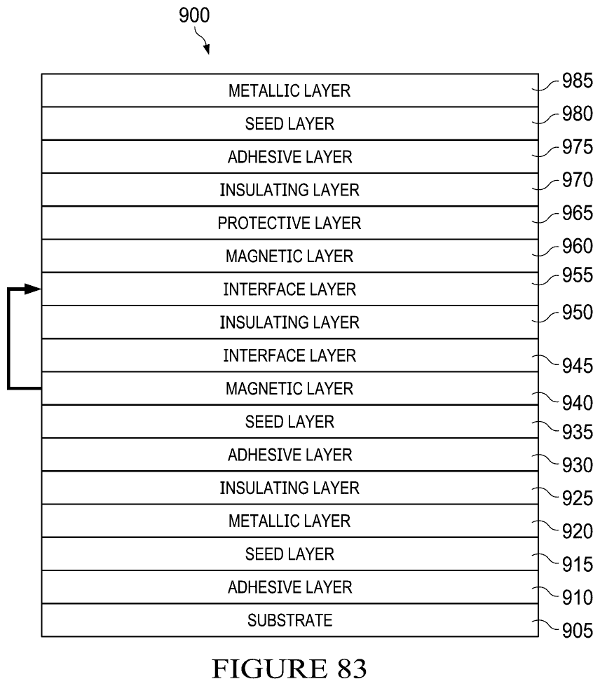

Turning now to FIG. 83, a second metallic layer 985 is deposited by a wet-bath electroplating process on the third seed layer 980. The second metallic layer 985 may be formed from copper, nickel, gold, aluminum, combination thereof (such as a stack of copper, nickel and gold) or other electrically conductive metallic material. The thickness of the second metallic layer 985 is, without limitation, about 20 microns (“μm”).

Thus, a micromagnetic device formed with a quaternary alloy with magnetic properties improved over those currently available, and related method, has been introduced herein formed over a substrate. In an advantageous embodiment, the quaternary alloy includes iron, cobalt, boron and phosphorus, and is an amorphous or nanocrystalline magnetic alloy.

In an embodiment, the micromagnetic device (900) includes a substrate (905), a first adhesive layer (910) over the substrate (905), a first seed layer (915) over the first adhesive layer (910), and a first metallic layer (920) over the first seed layer (915). The micromagnetic device (900) also includes first and second magnetic layers (940, 960, e.g., one to fifteen microns in thickness) over the first metallic layer (920) from a magnetic alloy including iron, cobalt, boron and phosphorous. A content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion (e.g., 70-95 atomic percent) of the magnetic alloy.

The magnetic alloy may also include at least one of sulfur, vanadium, chromium, rhodium, ruthenium, carbon, tin, bismuth, tungsten, and copper with a concentration in a range of 1 to 1000 parts per million. The magnetic alloy is an amorphous or nanocrystalline magnetic alloy.

The micromagnetic device (900) also includes a second metallic layer (985) over the second magnetic layer (960). The first and second metallic layers (920, 995) may be about 20 microns thick formed from copper, gold, aluminum, or other electrically conductive metallic material.

The micromagnetic device (900) also includes a first insulting layer (925), a second adhesive layer (930) and a second seed layer (935) between the first metallic layer (920) and the first magnetic layer (940). The micromagnetic device (900) also includes a first interface layer (945), a second insulting layer (950) and a second interface layer (955) between the first magnetic layer (940) and the second magnetic layer (960). The micromagnetic device (900) also includes a protective layer (965), a third insulting layer (970), a third adhesive layer (975) and a third seed layer (980) between the second magnetic layer (960) and the second metallic layer (985). The first, second and third adhesive layers (910, 930, 970) may include at least one of nickel, chromium, titanium, and titanium tungsten.

The first, second and third seed layers (915, 935, 980) may include at least one of copper, gold, titanium, titanium tungsten, nickel, nickel-iron, cobalt, ruthenium, platinum and titanium followed by a thin layer of copper or gold. The first, second and third seed layers (915, 935, 980) form a conductive layer onto which the first magnetic layer (940) and the first and second metallic layers (920, 985) are formed. The first, second and third insulating layers (925, 950, 970, e.g., a polymer, an aluminum oxide or silicon dioxide) can affect residual mechanical stress in the product due to differential thermal expansion of conductive, magnetic, and other layers during device processing steps. The first and second interface layers (945, 955) may include gold, nickel, nickel-iron, cobalt or molybdenum or a combination of consecutive layers of the above. The protective layer (965) may include at least one of titanium, titanium tungsten, chromium, and nickel.

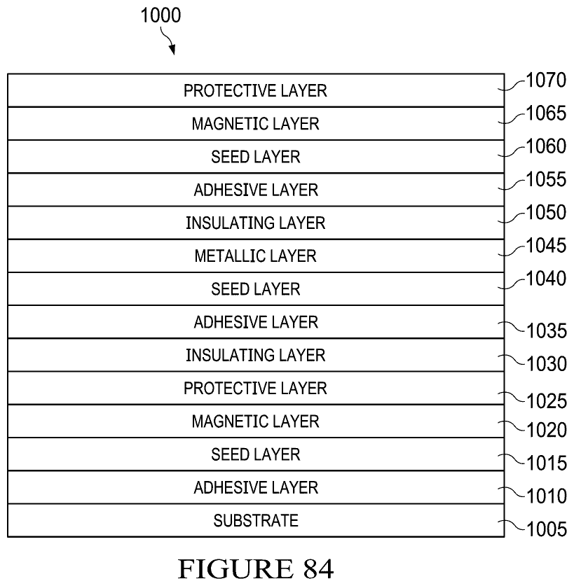

Turning now to FIG. 84, illustrated is a cross-sectional view of an embodiment of a micromagnetic device 1000. The micromagnetic device 1000 is formed on a substrate 1010 with a first adhesive layer 1010 formed thereover. A first seed layer 1015 is formed over the first adhesive layer 1010 and a first magnetic layer 1020 is formed over the first seed layer 1015. A first protective layer 1025 is formed over the first magnetic layer 1020, and a first insulating layer 1030 is formed over the first protective layer 1025. A second adhesive layer 1035 is formed over the first insulating layer 1030, a second seed layer 1040 is formed over the second adhesive layer 1035 and a metallic layer 1045 is formed over the second seed layer 1040. A second insulating layer 1050 is formed over the metallic layer 1045, and a third adhesive layer 1055 is formed over the second insulating layer 1050. A third seed layer 1060 is formed over the a third adhesive layer 1055, a second magnetic layer 1065 is formed over the third seed layer 1600, and a second protective layer 1070 is formed over the second magnetic layer 1065.

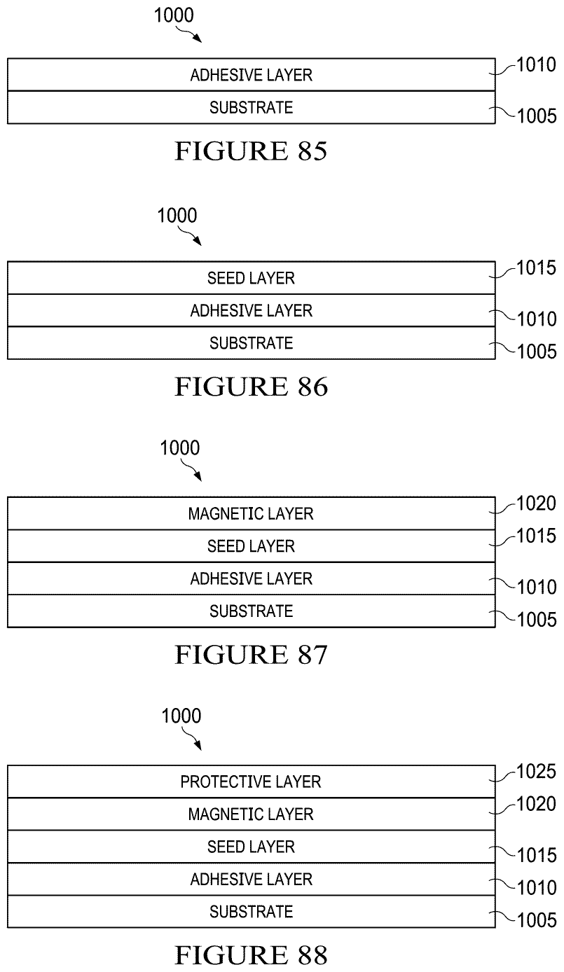

Turning now to FIGS. 85 to 97, illustrated are cross-sectional views of an embodiment of forming the micromagnetic device 1000 of FIG. 84. Beginning with FIG. 85, the micromagnetic device 1000 is constructed on a rigid or flexible substrate 1005 such as silicon, glass, ceramic, molded polymer, flex or printed circuit board substrate, or other insulating material of approximately 0.1 to one (1) millimeter (“mm”) of thickness. A first adhesive layer 1010 such as nickel, chromium, titanium, or titanium tungsten is deposited at about 100-600 angstroms (“Å”) of thickness on an upper surface of the substrate 1005 employing a sputtering, evaporation, lamination, cladding, electroplating or electroless process.

Turning now to FIG. 86, a first seed layer 1015 such as copper (or gold, titanium, titanium tungsten, nickel, nickel-iron, cobalt, ruthenium, platinum or titanium followed by a thin layer of copper or gold) is deposited on to the first adhesive layer 1010 employing a sputtering, evaporation, lamination, cladding, electroplating or electroless process for a later electroplating step. The first seed layer 1015 forms a conductive layer onto which a first magnetic layer 1020 will be deposited in a following processing step. The thickness of the first seed layer 1015 is in the range 1000-4000 Å preferably about 1500 Å. The first seed layer 1015 may include multiple layers of like or different materials that can serve as a seed layer. Of course, other layers described herein may also include multiple layers of like or different materials that can serve the purpose of the respective layer.

Turning now to FIG. 87, a first magnetic layer 1020 is deposited by a wet-bath electroplating process on the first seed layer 1015. The first magnetic layer 1020 includes boron in addition to iron, cobalt and phosphorous. The thickness of the first magnetic layer 1020 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product.

Regarding the first magnetic layer 1020, to provide an alloy with magnetic properties improved over alloys currently available, the quaternary alloy including iron, cobalt, boron and phosphorous is introduced. The first magnetic layer 1020 includes cobalt in the range of 1.0-8.0 atomic percent, boron in the range of 0.5-10 atomic percent, and iron in the range of 70-95 atomic percent. The first magnetic layer 1020 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the first magnetic layer 1020 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

Turning now to FIG. 88, a first protective layer 1025 such as titanium, titanium tungsten (“TiW”), chromium or nickel (or nickel-based) is deposited at about 100-1000 Å of thickness on an upper surface of the first magnetic layer 1020 employing a dry deposition, electroless or electroplating process. In accordance with the electroplating process, the micromagnetic device 1000 is rinsed with carbon dioxide (“CO₂”)-saturated, de-ionized water and then immersed in an aqueous electrolyte (e.g., a titanium tungsten aqueous electrolyte) to form the first protective layer 1025 over the first magnetic layer 1020.

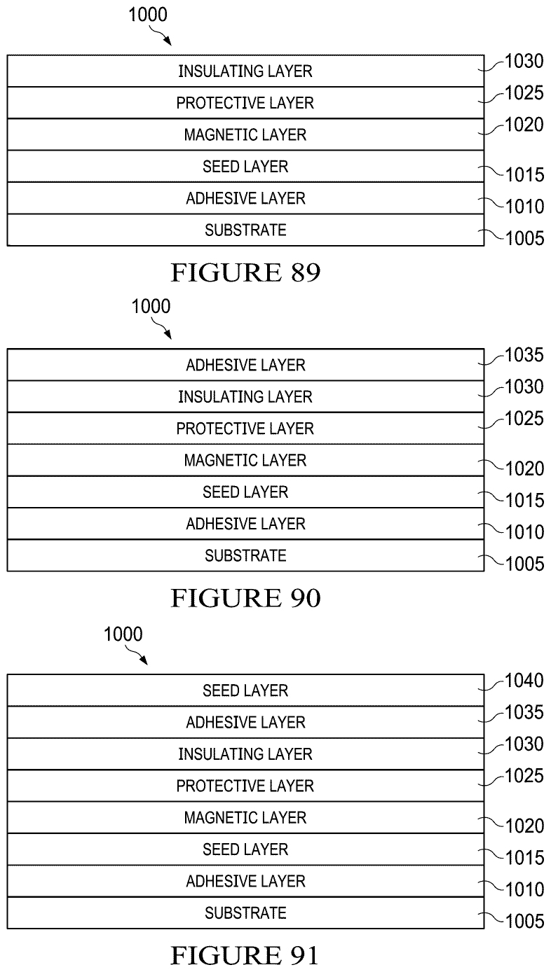

Turning now to FIG. 89, a first insulating layer 1030 is deposited on the first protective layer 1025. The first insulating layer 1030 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the first insulating layer 1030 is about, but not limited to, 0.02 to 5 microns (“μm”).

The thickness of the first insulating layer 1030 can affect residual mechanical stress in the product due to differential thermal expansion of conductive, magnetic, and other layers during device processing steps. The thickness of the first insulating layer 1030 can be adjusted using simulation or experimental techniques to produce a die with low residual mechanical stress after completion of micromagnetic device processing.

The first insulating layer 1030 can be formed with a deposition of a patternable layer (e.g., photosensitive photoresist, screen printed polymer or laser patternable coating with no or very low electric conductivity) on top of the first protective layer 1025, which is then hard cured by heating or other means. The first insulating layer 1030 can be a semi-insulating layer such as polypyrrole with a low level of electrical conductivity deposited by an electroplating process. Following electroplating, the first insulating layer 1030 is cured and annealed, which substantially reduces its conductivity. The result is a sufficiently high level of resistivity is obtained for a first insulating layer 1030 in the micromagnetic device 1000, thereby simplifying the total manufacturing process.

Turning now to FIG. 90, a second adhesive layer 1035 is formed over the first insulating layer 1030. The second adhesive layer 1035 such as nickel, chromium, titanium, or titanium tungsten is deposited at about 100-600 angstroms (“Å”) of thickness on the first insulating layer 1030 employing a sputtering, evaporation, lamination, cladding, electroplating or electroless process.

Turning now to FIG. 91, a second seed layer 1040 such as copper (or gold, titanium, titanium tungsten, nickel, nickel-iron, cobalt, ruthenium, platinum or titanium followed by a thin layer of copper or gold) is deposited on to the second adhesive layer 1035 employing a sputtering, evaporation, lamination, cladding, electroplating or electroless process for a later electroplating step. The second seed layer 1040 forms a conductive layer onto which a metallic layer 1045 will be deposited in a following processing step. The thickness of the second seed layer 1040 is in the range 1000-4000 Å preferably about 1500 Å. The second seed layer 1040 may include multiple layers of like or different materials that can serve as a seed layer. Of course, other layers described herein may also include multiple layers of like or different materials that can serve the purpose of the respective layer.

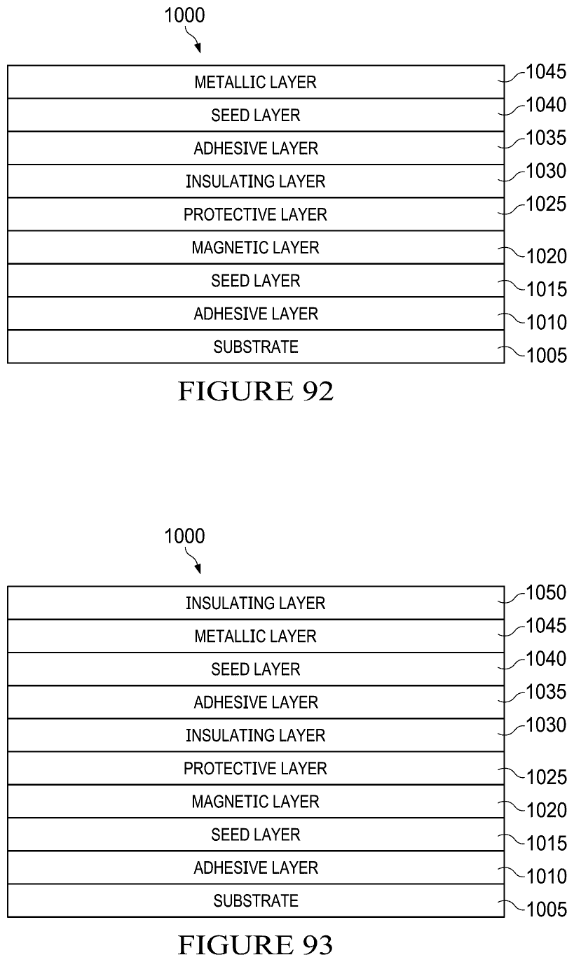

Turning now to FIG. 92, a metallic layer 1045 is deposited by a wet-bath electroplating process on the second seed layer 1040. The metallic layer 1045 may be formed from copper, nickel, gold, aluminum, combination thereof (such as a stack of copper, nickel and gold) or other electrically conductive metallic material. The thickness of the metallic layer 1045 is, without limitation, about 20 microns (“μm”).

Turning now to FIG. 93, a second insulating layer 1050 is deposited on the metallic layer 1045. The second insulating layer 1050 may include a polymer (e.g., hard baked photoresist or polypyrrole) that can be electroplated or, alternatively, an aluminum oxide or silicon dioxide insulating layer can be deposited using a vacuum deposition process such as chemical or physical vapor deposition. In an embodiment, the thickness of the second insulating layer 1050 is about, but not limited to, 0.02 to 5 microns (“μm”).

The thickness of the second insulating layer 1050 can affect residual mechanical stress in the product due to differential thermal expansion of conductive, magnetic, and other layers during device processing steps. The thickness of the second insulating layer 1050 can be adjusted using simulation or experimental techniques to produce a die with low residual mechanical stress after completion of micromagnetic device processing.

The second insulating layer 1050 can be formed with a deposition of a patternable layer (e.g., photosensitive photoresist, screen printed polymer or laser patternable coating with no or very low electric conductivity) on top of the metallic layer 1045, which is then hard cured by heating or other means. The second insulating layer 1050 can be a semi-insulating layer such as polypyrrole with a low level of electrical conductivity deposited by an electroplating process. Following electroplating, the second insulating layer 1050 is cured and annealed, which substantially reduces its conductivity. The result is a sufficiently high level of resistivity is obtained for a second insulating layer 1050 in the micromagnetic device 1000, thereby simplifying the total manufacturing process.

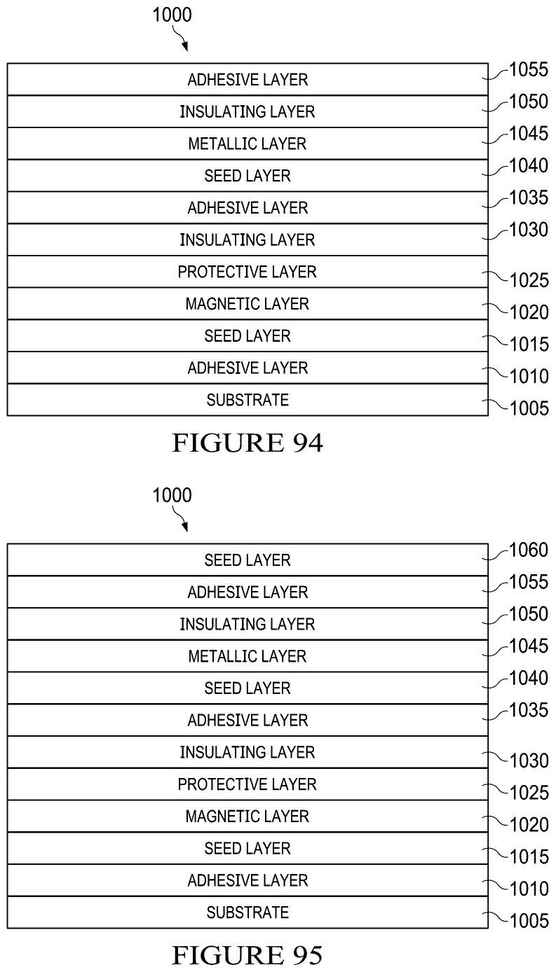

Turning now to FIG. 94, a third adhesive layer 1055 is formed over the second insulating layer 1050. The third adhesive layer 1055 such as nickel, chromium, titanium, or titanium tungsten is deposited at about 100-600 angstroms (“Å”) of thickness on the second insulating layer 1050 employing a sputtering, evaporation, lamination, cladding, electroplating or electroless process.

Turning now to FIG. 95, a third seed layer 1060 such as copper (or gold, titanium, titanium tungsten, nickel, nickel-iron, cobalt, ruthenium, platinum or titanium followed by a thin layer of copper or gold) is deposited on to the third adhesive layer 1055 employing a sputtering, evaporation, lamination, cladding, electroplating or electroless process for a later electroplating step. The third seed layer 1060 forms a conductive layer onto which a second magnetic layer 1065 will be deposited in a following processing step. The thickness of the third seed layer 1060 is in the range 1000-4000 Å preferably about 1500 Å. The third seed layer 1060 may include multiple layers of like or different materials that can serve as a seed layer. Of course, other layers described herein may also include multiple layers of like or different materials that can serve the purpose of the respective layer.

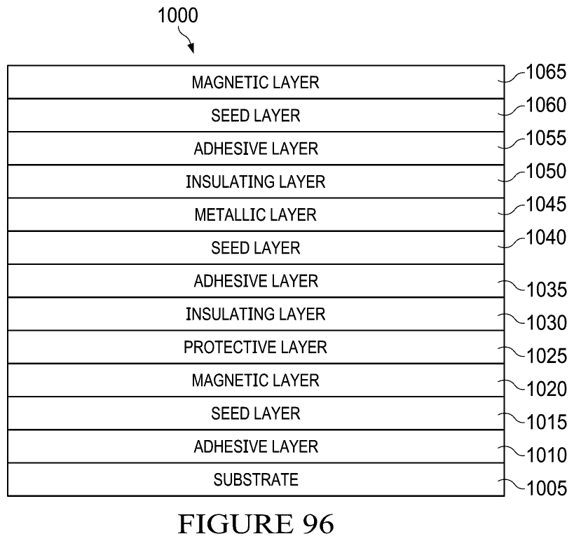

Turning now to FIG. 96, a second magnetic layer 1065 is deposited by a wet-bath electroplating process on the third seed layer 1060. The second magnetic layer 1065 includes boron in addition to iron, cobalt and phosphorous. The thickness of the second magnetic layer 1065 is, without limitation, about one (1) to fifteen (15) microns (“μm”), which is defined by the skin depth of a range of frequencies from 1 to 30 megahertz (“MHz”). The thickness is constrained to reduce core loss due to induced eddy currents in this magnetically permeable and electrically conductive layer at the switching frequency of a power converter or other product.

Regarding the second magnetic layer 1065, to provide an alloy with magnetic properties improved over alloys currently available, the quaternary alloy including iron, cobalt, boron and phosphorous is introduced. The second magnetic layer 1065 includes cobalt in the range of 1.0-8.0 atomic percent, boron in the range of 0.5-10 atomic percent, and iron in the range of 70-95 atomic percent. The first magnetic layer 1020 can further include phosphorus in the range of 3.5-25 atomic percent, thereby reducing the iron concentration. The alloy may also include trace amounts of sulfur, vanadium, chromium, rhodium, ruthenium, carbon, tin, bismuth, tungsten, copper, and/or combinations thereof, with a concentration of each in the range of one (1) to 1000 parts per million (“ppm”), to reduce stress and/or increase resistivity compared to the basic quaternary alloy without these trace elements.

The quaternary alloy employable with the second magnetic layer 1065 advantageously sustains a magnetic saturation flux density of about 1.2-2.0 tesla (12,000-20,000 gauss), and accommodates a power converter switching frequency of, without limitation, 20 MHz with low loss when electroplated in layers one (1) to fifteen (15) μm thick, each layer separated by an insulation layer (e.g., inorganic materials such as aluminum or silicon oxides and/or organic based materials such as, but not limited to, polymeric films) as set forth below. In comparison, soft ferrites of the past commonly used in the design of switch-mode power converters typically sustain a magnetic saturation flux density of only about 0.3 tesla. The quaternary alloy described herein is readily adaptable to a repeatable and continuing manufacturing process, and can provide long operational life in a typical application environment without substantial degradation of operating characteristics. The quaternary alloy can be electroplated with a sufficiently high current density to accommodate a low-cost manufacturing operation. The quaternary alloy can be readily electroplated in alternating layers with intervening insulating or semi-insulating layers onto a surface patterned, such as with a photoresist, to produce a micromagnetic device operable at a high switching frequency with a low level of power dissipation.

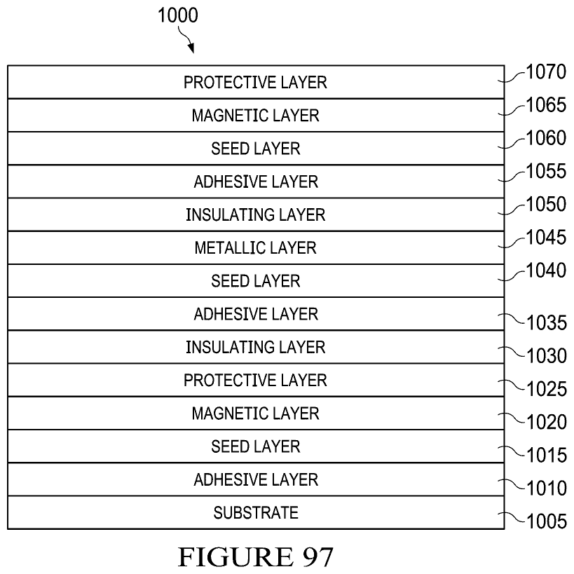

Turning now to FIG. 97, a second protective layer 1070 such as titanium, titanium tungsten (“TiW”), chromium or nickel (or nickel-based) is deposited at about 100-1000 Å of thickness on an upper surface of the second magnetic layer 1065 employing a dry deposition, electroless or electroplating process. In accordance with the electroplating process, the micromagnetic device 1000 is rinsed with carbon dioxide (“CO₂”)-saturated, de-ionized water and then immersed in an aqueous electrolyte (e.g., a titanium tungsten aqueous electrolyte) to form the second protective layer 1070 over the second magnetic layer 1070.

Thus, a micromagnetic device formed with a quaternary alloy with magnetic properties improved over those currently available, and related method, has been introduced herein formed over a substrate. In an advantageous embodiment, the quaternary alloy includes iron, cobalt, boron and phosphorus, and is an amorphous or nanocrystalline magnetic alloy.

In an embodiment, the micromagnetic device (1000) includes a substrate (1005), a first adhesive layer (1010) over the substrate (1005), a first seed layer (1015) over the first adhesive layer (1010), and a first magnetic layer (1020, e.g., one to fifteen microns in thickness) over the first seed layer (1015) from a magnetic alloy including iron, cobalt, boron and phosphorous. A content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion (e.g., 70-95 atomic percent) of the magnetic alloy. The micromagnetic device (1000) also includes a metallic layer (1045) over the first magnetic layer (1020), and a second magnetic layer (1065, analogous to the first magnetic layer 1020) over the metallic layer (1045). The metallic layer (1045) may be about 20 microns thick formed from copper, gold, aluminum, or other electrically conductive metallic material.

The magnetic alloy may also include at least one of sulfur, vanadium, chromium, rhodium, ruthenium, carbon, tin, bismuth, tungsten, and copper with a concentration in a range of 1 to 1000 parts per million. The magnetic alloy is an amorphous or nanocrystalline magnetic alloy.

The micromagnetic device (1000) also includes a first protective layer (1025), a first insulting layer (1030), and a second adhesive layer (1035) and a second seed layer (1040) between the first magnetic layer (1020) and the metallic layer (1045). The micromagnetic device (1000) also includes a second insulting layer (1050), and a third adhesive layer (1055) and a third seed layer (1060) between the metallic layer (1045) and the second magnetic layer (1065). The micromagnetic device (1000) also includes a second protective layer (1065) over the second magnetic layer (1065). The first, second and third adhesive layers (1010, 1035, 1055) may include at least one of nickel, chromium, titanium, and titanium tungsten. The first, second and third seed layers (1015, 1040, 1060) may include at least one of copper, gold, titanium, titanium tungsten, nickel, nickel-iron, cobalt, ruthenium, platinum and titanium followed by a thin layer of copper or gold. The first, second and third seed layers (1015, 1040, 1060) form a conductive layer onto which the first and second magnetic layers (1020, 1065) and the metallic layer (1045) are formed. The first and second insulating layers (1030, 1050, e.g., a polymer, an aluminum oxide or silicon dioxide) can affect residual mechanical stress in the product due to differential thermal expansion of conductive, magnetic, and other layers during device processing steps. The first and second protective layers (1025, 1070) may include at least one of titanium, titanium tungsten, chromium, and nickel.

A process to produce a micromagnetic device formed with thick, metallic winding (or coil) turns on a substrate, such as a thick, copper, spiral winding, employs depositing a photoresist on the substrate. After depositing the photoresist, the substrate is spun to form a thin photoresist layer, and is then dried. Light is directed through a reticle, and is focused with an optical lens on the photoresist to produce a pattern for the copper spiral winding that will be formed to produce the metallic winding. The process of depositing the photoresist, spinning, and drying (i.e., baking and curing the photoresist) is repeated generally at least 2-3 times for a 60-90 micrometers (“μm”) thick photoresist to form the desired thickness for the metallic winding on the substrate.

The aforementioned traditional process for forming metallic winding turns that may be 100 μm thick or more inefficiently adds cost and process time to forming the device. There is no current process to quickly produce and with low cost a thick metallic winding such as a thick copper spiral coil on a substrate. Accordingly, a faster and more cost-effective method of manufacturing thick metallic windings on a substrate compared to traditional photolithographic processes would be beneficial.

A dry, thick-film photolithographic process for constructing devices such as micromagnetic devices will now be described. The process enables production of wafer-level micromagnetic devices having metallic layers (or windings) with a thickness, without limitation, of 100 μm or more, and with spacing between winding segments (or inter-turn separations) that may only be, without limitation, 40 μm or less. The result is a faster and more cost-effective method of manufacturing wafer-level micromagnetic devices on substrates with thick windings, and with high aspect ratio, namely a high ratio of winding segment thickness to spacing between winding segments, compared to traditional photolithographic processes.

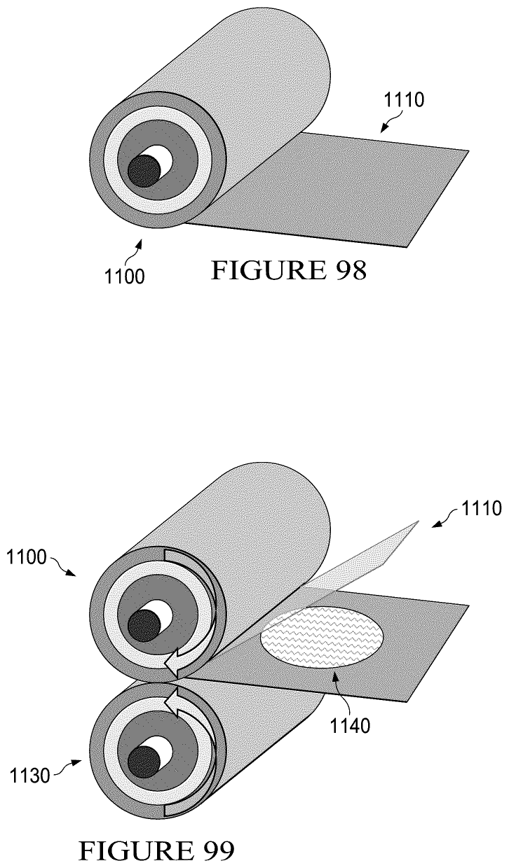

Turning now to FIG. 98, illustrated is a drawing showing an example of a roller 1100 wrapped with a photosensitive film 1110. The photosensitive film 1110 may be a dry 100 μm thick, photosensitive film. The roller 1100 with the photosensitive film 1110 may be employed to construct a metallic layer (winding or coil) as set forth below.

Turning now to FIG. 99, illustrated is a diagram showing a process configuration employed to laminate the photosensitive film 1110 of FIG. 98 over a substrate 1140. The upper roller 1100 includes the photosensitive film 1110 and a lower roller 1130 includes the substrate 1140 and also may include overlying layers. Effectively, the photosensitive film 1110 is laminated over the substrate 1140. In an alternative embodiment, a plurality of photosensitive films 1110 may be laminated over the substrate 1140 to obtain a desired thickness. As an example, two 50 μm photosensitive films 1110 may be laminated over the substrate 1140 to reach a desired thickness of 100 μm.

The substrate 1140 on which a metallic layer is to be formed adheres to the photosensitive film 1110 by pressure produced by the rollers 1100, 1130. The rollers 1100, 1130 can be heated as needed or can remain at room temperature. A photolithographic process is then applied to the photosensitive film 1110 that produces the metallic layer (winding or coil) with a high aspect ratio in one efficient processing iteration. There is no need for repeatedly applying, spinning, and drying a photoresist. The photosensitive film 1110 is available in various thicknesses, ranging from 5-300 μm and either a single layer or multiple layers of the photosensitive film can be processed appropriately to accommodate a thickness of the metallic layer very close to the photosensitive film 1110 such as 95 to 98 μm. Thus, the photosensitive film is employed to form metallic layer(s) in reduced processing steps as opposed to repeatedly applying and etching a photoresist to form thick apertures into which the metallic layer(s) will be formed.

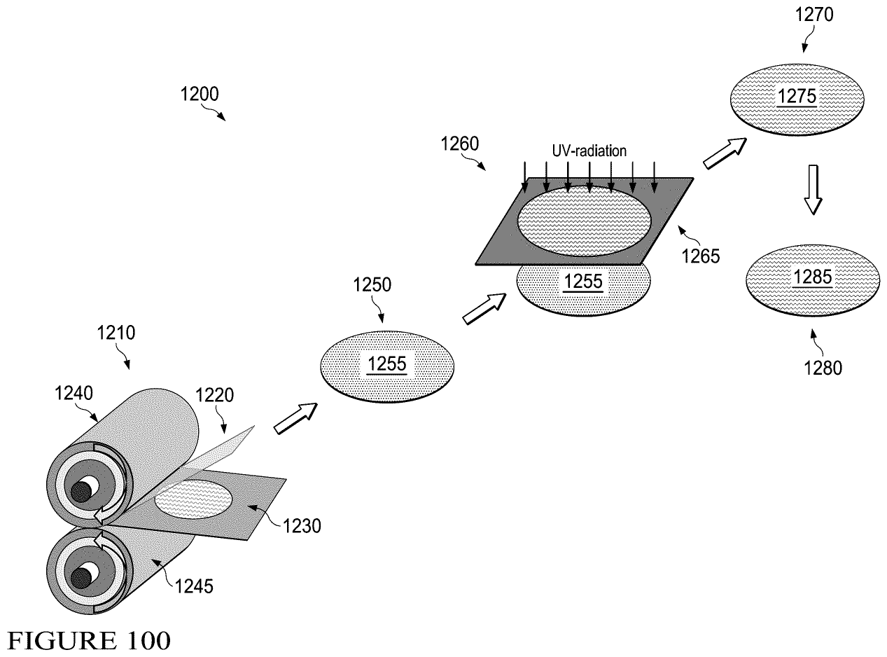

Turning now to FIG. 100, illustrated is a diagram of an embodiment of a method 1200 of forming a micromagnetic device. At a first step 1210, a photosensitive film 1220 on a first roller 1240 is laminated over a substrate 1230 (which also may include overlying layers) on a second roller 1245. There are numerous suppliers of such photosensitive dry laminate films such as Dupont, Asahi Kasei, Kolon Industries, Hitachi Chemicals and many others that provide films suitable for the micromagnetic device. The supplier, tone (positive or negative) and thickness of the photosensitive dry laminate films may be chosen based on the design constraints of the device being manufactured. The substrate 1230 on which a metallic layer is to be formed adheres to the photosensitive film 1220 by controlled pressure, for example in a range between 10-90 pounds-per-square inch (“psi”), which is produced by the rollers 1240, 1245 and maintained within an appropriate range of temperatures, for example between 70-140 degrees Celsius (“° C.”). The substrate 1230 may also be pre-heated to allow for better adhesion of the photosensitive film 1220 and improved stability through the remaining process sequence. The exit temperature of the substrate 1230 and laminated photosensitive film 1220 is monitored and used to provide feedback to the laminating equipment to enhance or optimize the lamination process. The speed of the lamination process is chosen to reduce or exclude defects such as entrapped air bubbles, improve adhesion and equipment capabilities. This is typically in a range of 0.1-5 meters-per-minute (“m/min”). (See, e.g., FIGS. 98 and 99 for an example lamination process).

At a second step 1250, the excess photosensitive film is cut to match the wafer shape to provide a laminated substrate 1255. At a third step 1260, a photolithography process using a mask 1265 and ultraviolet (“UV”) radiation is performed on the laminated substrate 1255. This step could be performed for example using a standard I-line UV aligner with an appropriate ultraviolet dosage typically between 20-200 milli-Joules-per-centimeters squared (“mJ/cm²”).

At a fourth step 1270, a pattern from the mask 1265 is transferred to the laminated substrate 1255 by a post exposure bake and photoresist development process. The development process is also chosen appropriate to the type of film chosen. Such developers are typically aqueous, and as an example alkaline (hydroxide) based developers may be used for positive tone films and carbonate based developers may be chosen for negative tone films. Suppliers and manufacturers of such photosensitive films typically provide guidance on appropriate selection of the type of developer and processing parameters. The result is a patterned laminated substrate 1275.

At a fifth step 1280, features of the micromagnetic device are electroplated and the laminated photosensitive film is removed by, for instance, a wet photoresist stripping process and to form a micromagnetic device 1285. Similar to the choice of developers, typical solutions used for stripping are also suggested by the manufacturer of the photosensitive film, depending on the type of processing employed and contain several components proprietary to the manufacturer such as surfactants and anti-oxidants. For the process of stripping, commercially available aqueous alkaline stripping solutions as described earlier may be employed at elevated temperatures between 30-80° C. This is typically accompanied by vigorous agitation onto the substrate. Since a significant portion of the photosensitive film and its components may not dissolve in the solution, an inline filtration of the solution to remove particulates and pieces of the photosensitive film that have been removed from the substrate as part of the stripping process may be necessary. It should be noted that FIG. 100 is a conceptual representation of, for instance, the laminated substrate 1255, patterned laminated substrate 1275 and micromagnetic device 1285. The features of the respective devices are delineated with respect to other FIGUREs herein.

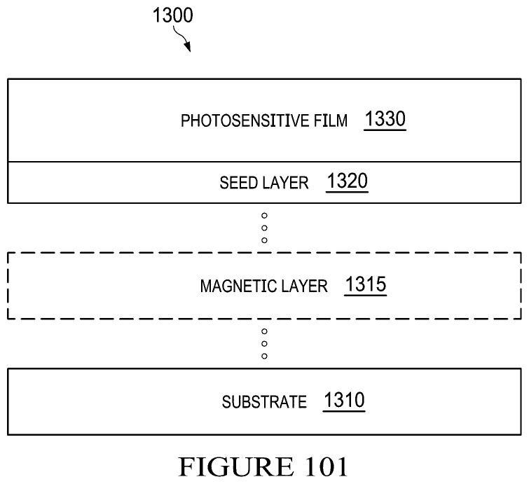

Turning now to FIGS. 101 to 105, illustrated are cross-sectional views of an embodiment of forming winding segments. Beginning with FIG. 101, a micromagnetic device 1300 includes a photosensitive film 1330 (e.g., 100 μm thick) laminated over a seed layer 1320, which has been formed over a substrate 1310. The separation of the substrate 1310 and seed layer 1320 represent that there may be intervening layers such as a magnetic layer 1315 therebetween. See the micromagnetic devices disclosed herein for the process to form the magnetic layer 1315 and the seed layer 1320 and representative materials for the substrate 1310, the magnetic layer 1315 and the seed layer 1320. For instance, the magnetic layer 1315 may include a magnetic alloy with iron, cobalt, boron and phosphorous. A content of the cobalt is in a range of 1.0 to 8.0 atomic percent. A content of the boron is in a range of 0.5 to 10 atomic percent. A content of the phosphorus is in a range of 3.5 to 25 atomic percent, and a content of the iron is substantially a remaining proportion of the magnetic alloy.

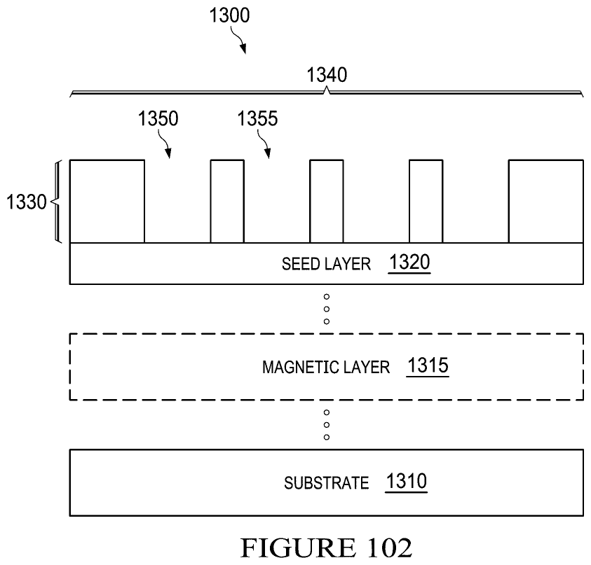

Turning now to FIG. 102, the photosensitive film 1330 is exposed through a reticle to define a pattern (generally designated 1340) on the photosensitive film 1330. The photosensitive film 1330 is then developed to form an aperture(s) (two of which are designated 1350, 1355) based on the pattern 1340 on the photosensitive film 1330.

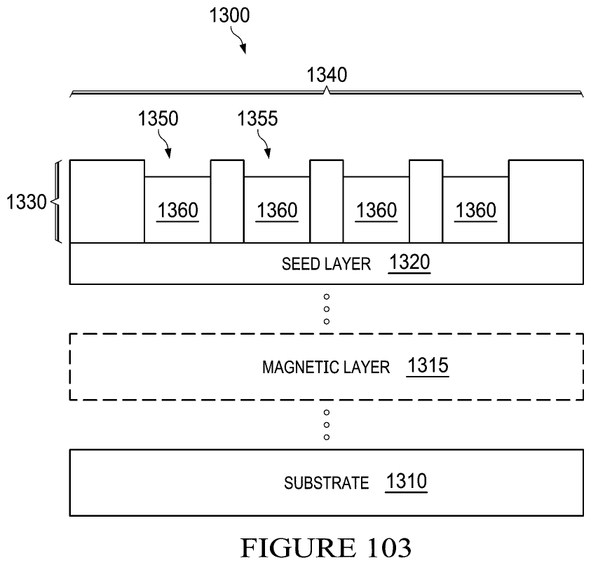

Turning now to FIG. 103, a metallic layer 1360 is deposited within the aperture(s) 1350, 1355. The metallic layer 1360 may be deposited by a wet-bath electroplating process. The metallic layer 1360 may be formed from copper, nickel, gold, aluminum, combination thereof (such as a stack of copper, nickel and gold) or other electrically conductive metallic material. The thickness of the metallic layer 1360 is, without limitation, about 90 μm. Of course, the thickness of the metallic layer 1360 is a function of a thickness of the photosensitive film 1330. In this example, the metallic layer 1360 is 90 μm thick with a photosensitive film 1330 of 100 μm thick. In another example, the metallic layer 1360 may be 10 μm thick with a photosensitive film 1330 of about 12 μm thick. The thickness of the layers is dependent on the application and may vary.

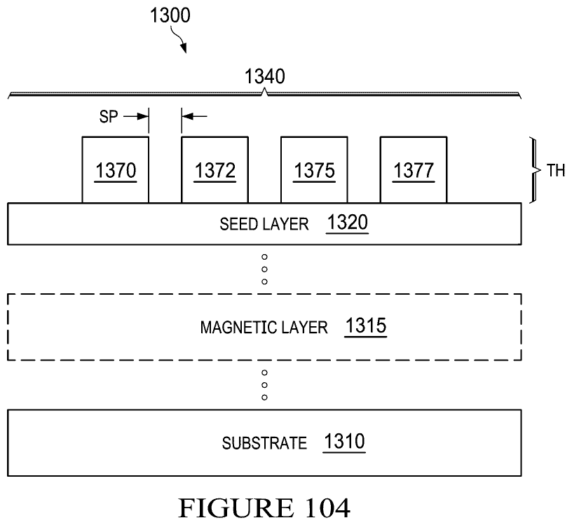

Turning now to FIG. 104, the remaining photosensitive film 1330 is removed using a suitable photosensitive film chemical immersion stripping process to create first, second, third and fourth winding segments 1370, 1372, 1375, 1377. In this case, an aspect ratio representing a thickness (“TH”) of a winding segment (e.g., 90 μm) to a line spacing dimension or spacing (“SP”, e.g., 40 μm) between a winding segment (e.g., the first winding segment 1370) and another winding segment (e.g., the second winding segment 1372) is greater than two-to-one. In general, the aspect ratio may be at least one-to-one.

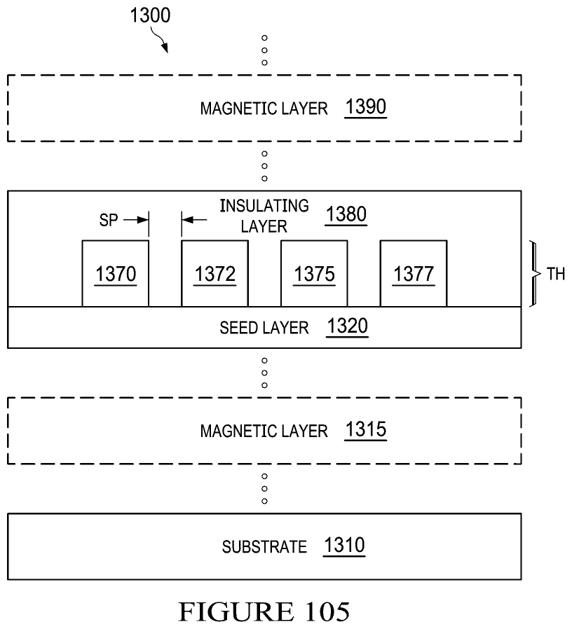

Turning now to FIG. 105, an insulating layer 1380 is formed over the metallic layer forming the winding with the first, second, third and fourth winding segments 1370, 1372, 1375, 1377. Also, there may be overlaying layers such as another magnetic layer 1390 over the insulating layer 1380. See the micromagnetic devices disclosed herein for the process to form the insulating layer 1380 and the another magnetic layer 1390 and the representative materials therefor.

Thus, a device (such as a micromagnetic device 1300), and related method of forming the same, has been introduced herein (see, e.g., FIGS. 101 to 105). In an embodiment, the device (1300) includes a seed layer (1320) over a substrate (1310), and a metallic layer (1360) electroplated within an aperture (1350) in a photosensitive film (1330) laminated over the seed layer (1320) to produce a winding segment (1370, e.g., having a thickness of at least 10 microns). The aperture (1350) is formed by exposing the photosensitive film (1330) through a reticle to define a pattern (1340) and developing the photosensitive film (1330) to form the aperture (1350) based on the pattern (1340).

The metallic layer (1360) may include another winding segment (1372) electroplated within another aperture (1355) in the photosensitive film (1330). The another aperture (1355) is formed by exposing the photosensitive film (1330) through the reticle to define the pattern (1340) and developing the photosensitive film (1330) to form the another aperture (1355) based on the pattern (1340). An aspect ratio representing a thickness (TH) of the winding segment (1370) to a spacing (SP) between the winding segment (1370) and the another winding segment (1372) is at least one-to-one. It should be noted that the thickness (TH) of the winding segment (1370) and the another winding segment (1372) may be different, and spacing (SP) between multiple winding segments can be different. The winding segment (1370) and the another winding segment (1372) may form at least a portion of a spirally shaped winding. Of course, the device (1300) may include a single winding segment or multiple winding segments.

The device (1300) may also include an insulating layer (1380) formed over the winding segment (1370) and the another winding segment (1372). The device (1300) may further include a magnetic layer (1315) formed between the substrate (1310) and the seed layer (1320), and another magnetic layer (1390) formed over the insulating layer (1380). Of course, the device (1300) may include a single magnetic layer or multiple magnetic layers. The magnetic layer (1315) and/or the another magnetic layer (1390) may include a magnetic alloy including iron, cobalt, boron and phosphorous, wherein a content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion of the magnetic alloy.

In another embodiment, the method of forming the device (such as a micromagnetic device 1300) includes forming a seed layer (1320) over a substrate (1310), laminating a photosensitive film (1330) over the seed layer (1320), and exposing the photosensitive film (1330) through a reticle to define a pattern (1340) on the photosensitive film (1330). The method also includes developing the photosensitive film (1330) to form an aperture (1350) based on the pattern (1340) in the photosensitive film (1330), and electroplating a metallic layer (1360) within the aperture (1350) to produce a winding segment (1370, e.g., having a thickness of at least 10 microns).

The method may also include developing the photosensitive film (1330) to form another aperture (1355) based on the pattern (1340) in the photosensitive film (1330), and electroplating the metallic layer (1360) within the another aperture (1355) to produce another winding segment (1372). An aspect ratio representing a thickness (TH) of the winding segment (1370) to a spacing (SP) between the winding segment (1370) and the another winding segment (1372) is at least one-to-one. It should be noted that the thickness (TH) of the winding segment (1370) and the another winding segment (1372) may be different, and spacing (SP) between multiple winding segments can be different. The winding segment (1370) and the another winding segment (1372) may form at least a portion of a spirally shaped winding. Of course, the device (1300) may include a single winding segment or multiple winding segments.

The method may also include forming an insulating layer (1380) over the winding segment (1370) and the another winding segment (1372). The method may further include forming a magnetic layer (1315) over the substrate (1310) prior to forming the seed layer (1320), and forming another magnetic layer (1390) over the insulating layer (1380). Of course, the device (1300) may include a single magnetic layer or multiple magnetic layers. The magnetic layer (1315) and/or the another magnetic layer (1390) may include a magnetic alloy including iron, cobalt, boron and phosphorous, wherein a content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion of the magnetic alloy.

TABLE 1 below shows in a sequence of columns examples of typical coating time, exposure time, developing time, bake time, strip time, and total processing time to produce a metallic layer (e.g., copper winding) employing a conventional (“spinner”) process and the photolithographic process (“laminator”) introduced herein. Data are compared in TABLE 1 as illustrated in the leftmost column for copper winding thicknesses of 10, 30, 60, and 100 μm. Coating time grows with film thickness for a conventional process, but remains at 0.5 minutes for the laminating process illustrated in FIG. 100. Similarly, exposure time, developing time, baking time, and stripping time after plating grows substantially for the conventional process, but grows much less for the photolithographic process. The result is that the total processing time for the photolithographic process is substantially less than that for a conventional process.

TABLE I

| | | | | | Bake | Strip | | |
|---|---|---|---|---|---|---|---|---|
| | | | | | Time | Time | | Delta |
| Process | | Coating | Expose | Develop | (if | (Post | | (process |
| (Film | | Time | Time | Time | needed) | Plating) | Total | time |
| Thickness) | Equipment | (min) | (min) | (min) | (min) | (min) | (min) | savings) |
| 10 μm file | Spinner | 1.5 | 1.5 | 6 | 8 | 3 | 20 | |
| | Laminator | 0.5 | 0.3 | 2 | 0 | 3 | 5.8 | −71% |
| 30 μm file | Spinner | 2 | 2 | 8 | 10 | 3 | 25 | |
| | Laminator | 0.5 | 0.5 | 2 | 0 | 3 | 6 | −76% |
| 60 μm file | Spinner | 8 | 3 | 10 | 25 | 3 | 49 | |
| | (3 spins) | | | | | | | |
| | Laminator | 0.5 | 1 | 3 | 0 | 4 | 8.5 | −83% |
| 100 μm file | Spinner | 1.5 | 5 | 10 | 30 | 5 | 51.5 | |
| | (NXT) | | | | | | | |
| | Laminator | 0.5 | 1.5 | 4 | 0 | 5 | 11 | −79% |

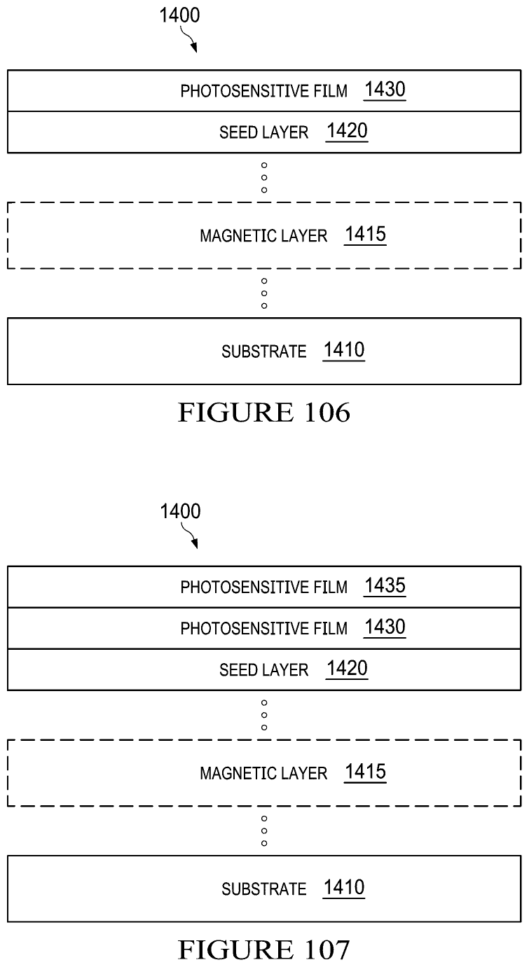

Turning now to FIGS. 106 to 111, illustrated are cross-sectional views of another embodiment of forming winding segments. Beginning with FIG. 106, a micromagnetic device 1400 includes a first photosensitive film 1430 (e.g., 50 μm thick) laminated over a seed layer 1420, which has been formed over a substrate 1410. The separation of the substrate 1410 and seed layer 1420 represent that there may be intervening layers such as a magnetic layer 1415 therebetween. See the micromagnetic devices disclosed herein for the process to form the magnetic layer 1415 and the seed layer 1420 and representative materials for the substrate 1410, the magnetic layer 1415 and the seed layer 1420. For instance, the magnetic layer 1415 may include a magnetic alloy with iron, cobalt, boron and phosphorous. A content of the cobalt is in a range of 1.0 to 8.0 atomic percent. A content of the boron is in a range of 0.5 to 10 atomic percent. A content of the phosphorus is in a range of 3.5 to 25 atomic percent, and a content of the iron is substantially a remaining proportion of the magnetic alloy.

Turning now to FIG. 107, a second photosensitive film 1435 (e.g., 50 μm thick) is laminated over the first photosensitive film 1430, which has been formed over a substrate 1410. Of course, the micromagnetic device may incorporate multiple layers of photosensitive film of like or different thickness.

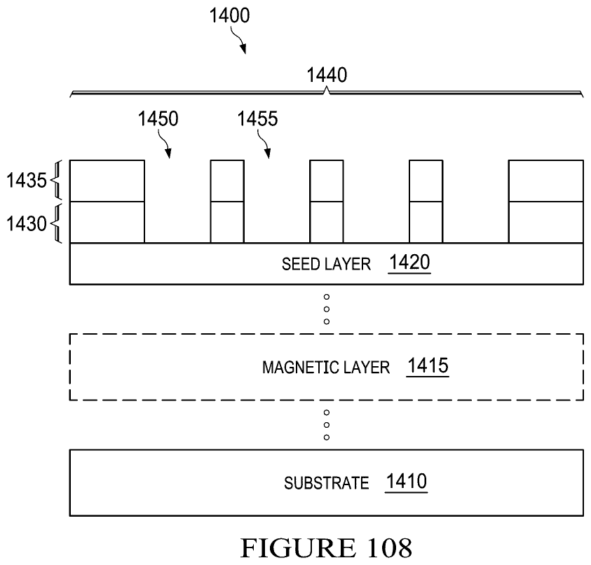

Turning now to FIG. 108, the first and second photosensitive films 1430, 1435 are exposed through a reticle to define a pattern (generally designated 1440) on the photosensitive films 1430, 1435. The photosensitive films 1430, 1434 are then developed to form an aperture(s) (two of which are designated 1450, 1455) based on the pattern 1440 on the photosensitive films 1430, 1435.

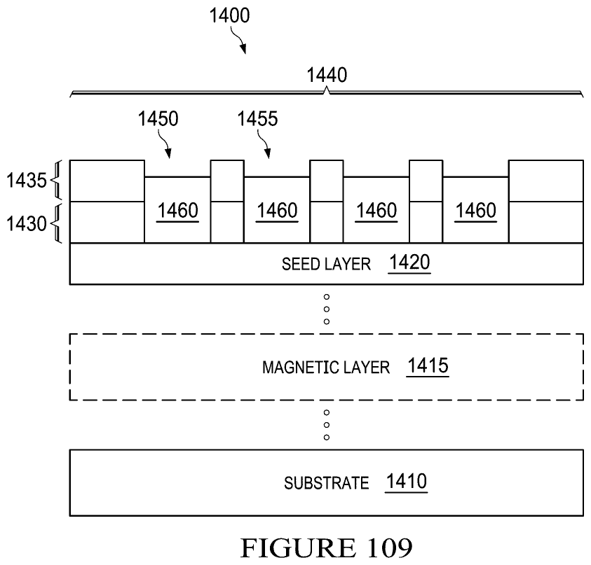

Turning now to FIG. 109, a metallic layer 1460 is deposited within the aperture(s) 1450, 1455. The metallic layer 1460 may be deposited by a wet-bath electroplating process. The metallic layer 1460 may be formed from copper, nickel, gold, aluminum, combination thereof (such as a stack of copper, nickel and gold) or other electrically conductive metallic material. The thickness of the metallic layer 1460 is, without limitation, about 90 μm. Of course, the thickness of the metallic layer 1460 is a function of a thickness of the photosensitive films 1430, 1435. In this example, the metallic layer 1460 is 90 μm thick with the photosensitive films 1430, 1435 of 100 μm thick. In another example, the metallic layer 1460 may be 10 μm thick with the photosensitive films 1430, 1435 of about 12 μm thick. The thickness of the layers is dependent on the application and may vary.

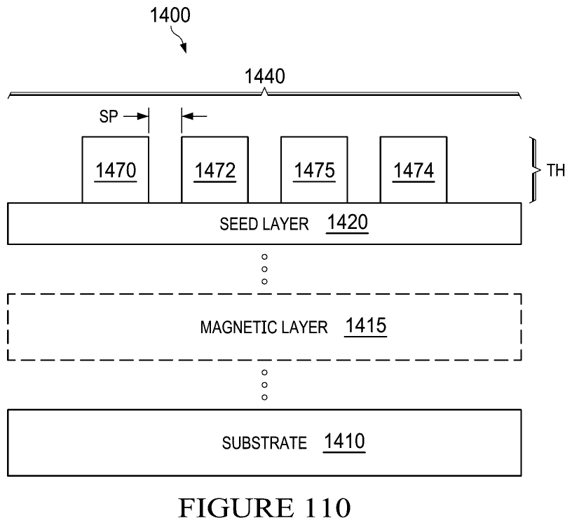

Turning now to FIG. 110, the remaining photosensitive films 1430, 1435 are removed using a suitable photosensitive film chemical immersion stripping process to create first, second, third and fourth winding segments 1470, 1472, 1475, 1477. In this case, an aspect ratio representing a thickness (“TH”) of a winding segment (e.g., 90 μm) to a spacing (“SP”, e.g., 40 μm) between a winding segment (e.g., the first winding segment 1470) and another winding segment (e.g., the second winding segment 1472) is greater than two-to-one. In general, the aspect ratio may be at least one-to-one.

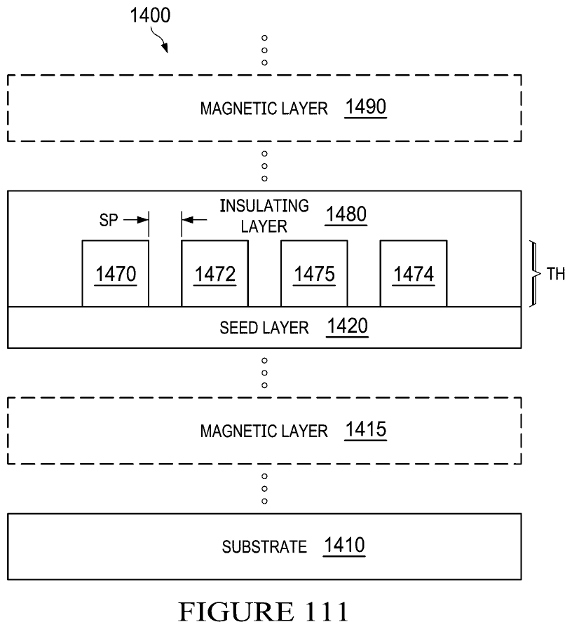

Turning now to FIG. 111, an insulating layer 1480 is formed over the metallic layer forming the winding with the first, second, third and fourth winding segments 1470, 1472, 1475, 1477. Also, there may be overlaying layers such as another magnetic layer 1490 over the insulating layer 1480. See the micromagnetic devices disclosed herein for the process to form the insulating layer 1480 and the another magnetic layer 1490 and the representative materials therefor.

Thus, a device (such as a micromagnetic device 1400), and related method of forming the same, has been introduced herein (see, e.g., FIGS. 106 to 111). In an embodiment, the device (1400) includes a seed layer (1420) over a substrate (1410), and a metallic layer (1460) electroplated within an aperture (1450) in a first photosensitive film (1430) and a second photosensitive film (1435) laminated over the seed layer (1420) to produce a winding segment (1470, e.g., having a thickness of at least 10 microns). The aperture (1450) is formed by exposing the first photosensitive film (1430) and the second photosensitive film (1435) through a reticle to define a pattern (1440) and developing the first photosensitive film (1430) and the second photosensitive film (1435) to form the aperture (1450) based on the pattern (1440). The second photosensitive film (1435) may be exposed concurrently with the first photosensitive film (1430), and the second photosensitive film (1435) may be developed concurrently with the first photosensitive film (1430).

The metallic layer (1460) may include another winding segment (1472) electroplated within another aperture (1455) in the first photosensitive film (1430) and the second photosensitive film (1435). The another aperture (1455) is formed by exposing the first photosensitive film (1430) and the second photosensitive film (1435) through the reticle to define the pattern (1440) and developing the first photosensitive film (1430) and the second photosensitive film (1435) to form the another aperture (1455) based on the pattern (1440). An aspect ratio representing a thickness (TH) of the winding segment (1470) to a spacing (SP) between the winding segment (1470) and the another winding segment (1472) is at least one-to-one. It should be noted that the thickness (TH) of the winding segment (1470) and the another winding segment (1472) may be different, and spacing (SP) between multiple winding segments can be different. The winding segment (1470) and the another winding segment (1472) may form at least a portion of a spirally shaped winding. Of course, the device (1400) may include a single winding segment or multiple winding segments.

The device (1400) may also include an insulating layer (1480) formed over the winding segment (1470) and the another winding segment (1472). The device (1400) may further include a magnetic layer (1415) formed between the substrate (1410) and the seed layer (1420), and another magnetic layer (1490) formed over the insulating layer (1480). Of course, the device (1400) may include a single magnetic layer or multiple magnetic layers. The magnetic layer (1415) and/or the another magnetic layer (1490) may include a magnetic alloy including iron, cobalt, boron and phosphorous, wherein a content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion of the magnetic alloy.

In another embodiment, the method of forming the device (such as a micromagnetic device 1400) includes forming a seed layer (1420) over a substrate (1410), laminating a first photosensitive film (1430) and a second photosensitive film (1435) over the seed layer (1420), and exposing (e.g., concurrently or at different steps or time) the first photosensitive film (1430) and the second photosensitive film (1435) through a reticle to define a pattern (1440) on the first photosensitive film (1430) and the second photosensitive film (1435). The method also includes developing (e.g., concurrently or at different steps or time) the first photosensitive film (1430) and the second photosensitive film (1435) to form an aperture (1450) based on the pattern (1440) in the first photosensitive film (1430) and the second photosensitive film (1435), and electroplating a metallic layer (1460) within the aperture (1450) to produce a winding segment (1470, e.g., having a thickness of at least 10 microns).

The method may also include developing the first photosensitive film (1430) and the second photosensitive film (1435) to form another aperture (1455) based on the pattern (1440) in the first photosensitive film (1430) and the second photosensitive film (1435), and electroplating the metallic layer (1460) within the another aperture (1455) to produce another winding segment (1472). An aspect ratio representing a thickness (TH) of the winding segment (1470) to a spacing (SP) between the winding segment (1470) and the another winding segment (1472) is at least one-to-one. It should be noted that the thickness (TH) of the winding segment (1470) and the another winding segment (1472) may be different, and spacing (SP) between multiple winding segments can be different. The winding segment (1470) and the another winding segment (1472) may form at least a portion of a spirally shaped winding. Of course, the device (1400) may include a single winding segment or multiple winding segments.

The method may also include forming an insulating layer (1480) over the winding segment (1470) and the another winding segment (1472). The method may further include forming a magnetic layer (1415) over the substrate (1410) prior to forming the seed layer (1420), and forming another magnetic layer (1490) over the insulating layer (1480). Of course, the device (1400) may include a single magnetic layer or multiple magnetic layers. The magnetic layer (1415) and/or the another magnetic layer (1490) may include a magnetic alloy including iron, cobalt, boron and phosphorous, wherein a content of the cobalt is in a range of 1.0 to 8.0 atomic percent, a content of the boron is in a range of 0.5 to 10 atomic percent, a content of the phosphorus is in a range of 3.5 to 25 atomic percent, and a content of the iron is substantially a remaining proportion of the magnetic alloy.

Although the embodiments introduced herein and its advantages have been described in detail, it should be understood that various changes, substitutions, and alterations can be made herein without departing from the spirit and scope thereof as defined by the appended claims. Also, many of the features, functions, and steps of operating the same can be reordered, omitted, added, etc., and still fall within the broad scope of the various embodiments.

Moreover, the scope of the various embodiments is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized as well. Accordingly, the appended claims are intended to include within their scope such processes, machines, manufacture, compositions of matter, means, methods, or steps.

What is claimed:

1. A micromagnetic device, comprising:
a substrate;
a seed layer over said substrate; and
a magnetic layer over said seed layer.
